(19) United States
(12) Patent Application Publication
(10) Pub. No.: US 2016/0350699 A1
(43) Pub. Date: Dec. 1, 2016

(54) SYSTEM AND METHOD FOR QUALITY MANAGEMENT PLATFORM

(71) Applicant: Genesys Telecommunications Laboratories, Inc., Daly City, CA (US)

(72) Inventors: Leon Vymenets, Toronto (CA); Cayley MacArthur, Cambridge (CA); Yochai Konig, San Francisco, CA (US); Wayne Lo, Toronto (CA); Praphul Kumar, Falls Church, VA (US); Herbert Ristock, Walnut Creek, CA (US)

(21) Appl. No.: 14/726,491

(22) Filed: May 30, 2015

(51) Int. Cl. G06Q 10/06; G06Q 30/00

(52) U.S. Cl. CPC G06Q 10/063118; G06Q 10/06398; G06Q 30/016

(57) ABSTRACT

A system includes a contact center to provide an interaction between a customer and agent. A forms manager of the contact center generates a question for an evaluation form. A workforce management server connects with the forms manager, the workforce management server to schedule a work time for the agent. The workforce management server to schedule the forms manager to generate the evaluation form when the agent is working.

### BACKGROUND

Contact centers can include offices set up to handle large volumes calls, emails, chats, texts, letters, and other interactions with customers. The contact centers can screen interactions, forward the interactions to someone qualified to handle them, and to log the interactions. Contact centers can be used by mail-order catalog organizations, telemarketing companies, computer product help desks, and any large organization that uses the telephones, etc. to sell or service products and services.

### BRIEF DESCRIPTION OF THE DRAWINGS

In association with the following detailed description, reference is made to the accompanying drawings, where like numerals in different figures can refer to the same element.

FIG. 1 is a block diagram of an exemplary architectural overview of a contact center.

FIG. 2 is a screenshot of an example screen for a forms manager of the quality management platform.

FIG. 3 is a screenshot of an example form template for building a form.

FIG. 4 is a screenshot of an example of an interface for building the form.

FIG. 5 is a screenshot of an example user interface screen for weighting questions.

FIG. 6 is a screenshot of an example user interface screen for weighting by answer.

FIG. 7 is a screenshot of an example user interface screen for weighing by group.

FIG. 8 is another screenshot of the form template, e.g., to build or edit a form.

FIG. 9 is a screenshot of an example user interface screen for inserting a library item to the form.

FIG. 10 is another screenshot of an example user interface screen for inserting a library item to the form.

FIG. 11 is a screenshot of an example user interface screen for an evaluations manager of the quality management platform.

FIG. 12 is screenshot of an example matrix of evaluation types for creating an evaluation.

FIG. 13 is a screenshot of an example user interface screen for managing evaluations.

FIG. 14 is a screenshot of an example form preview interface screen.

FIG. 15 is a screenshot of an example interface screen to add questions to the evaluations.

FIG. 16 is a screenshot of an example interface screen to generate evaluations based on selected interactions and/or criteria.

FIG. 17 is a screenshot of an example video display of the interface screen.

FIG. 18 is a screenshot of an example save input screen for the evaluations.

FIG. 19 is a screenshot of an example evaluations schedule for completing evaluations.

FIG. 20 is a screenshot of an example screen for an open evaluation.

FIG. 21 is a screenshot of an example screen for sharing an evaluation.

FIG. 22 is a screenshot of an example screen for generating calibration reports.

FIG. 23 is a screenshot of an example screen for a calibration report.

FIGS. 24A and 24B are a screenshots of an example screen for displaying average evaluations scores by agent team.

FIGS. 25A and 25B are a screenshots of an example screen for displaying average evaluation scores for individual teams.

FIG. 26 is a screenshot of an example screen for displaying average evaluation scores for an individual agent.

FIGS. 27A and 27B is a screenshot of a screen of an example screen for displaying completed evaluation sets.

### DETAILED DESCRIPTION

A goal of the contact centers can be to provide quality customer service. Systems and methods can provide for a quality management platform that builds forms to help evaluate interactions by customers with agents at contact centers. The forms can be completed when quality analysis is performed on recordings of customer interactions with the contact centers and contact center agents. By analyzing the completed forms, strengths and weaknesses of the interactions processing can be determined. Training, repositioning of agents, employment decisions, etc. can be performed based on the analysis.

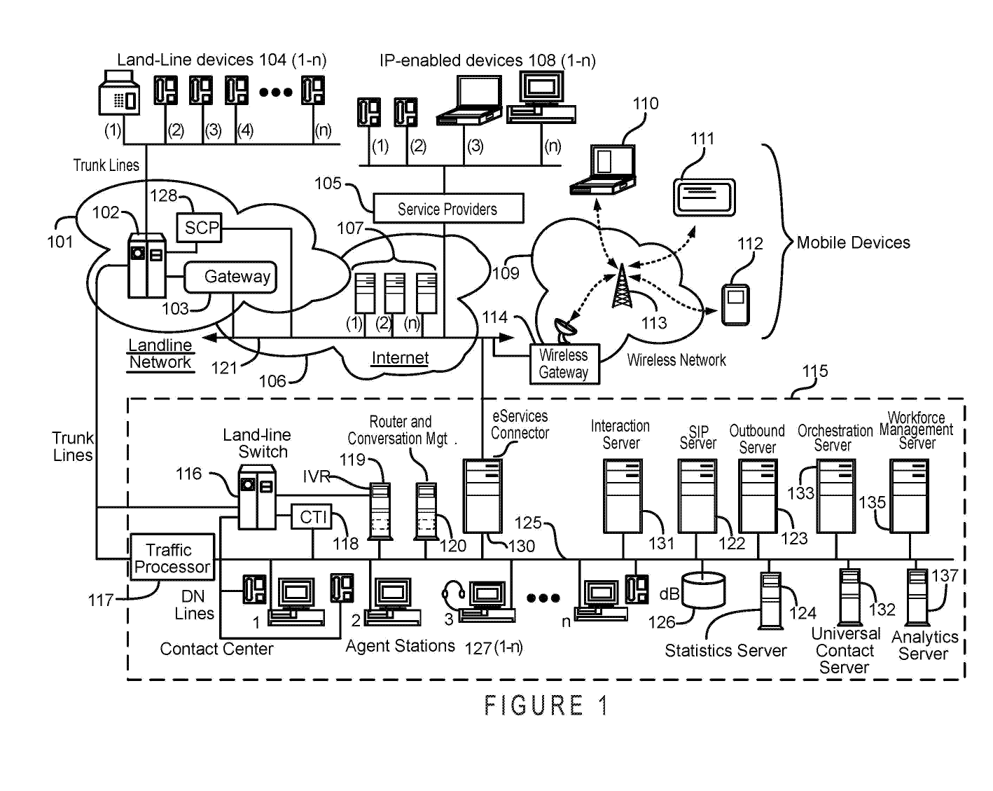

FIG. 1 is a block diagram illustrating a contact center 115 and a plurality of networks with interconnections where customers may interact with agents of the contact center. More or less of the modules discussed with the contact center 115 can be used, e.g., depending on an implementation. The modules can be located at the same physical location, at different physical locations, and/or virtually in a cloud, etc. The contact center 115 may be hosted by an enterprise and the enterprise may employ more than one contact center. Customers and agents may interact with contact center 115 through communication appliances such as land-line devices, e.g., telephones and facsimile machines 104(1-n), IP-enabled devices 108(1-n), e.g., laptop or desktop computer and IP-enabled phones, through mobile devices 110, 111 or 112, e.g., mobile phones, smart phones, personal digital assistants, tablets, etc. Interactions may include voice, text interaction, email, messaging services chat, facsimiles, mailed letters, and so on.

In one example of a contact center 115, interactions through land-line devices 104 may connect over trunk lines as shown to a network switch 102. Switch 102 may interact with hardware and software of a Service Control Point (SCP) 128, which may execute intelligent operations to determine to connect an incoming call to different ones of possible contact centers or to route an incoming call and facsimiles to an agent in a contact center or to an agent operating as a remote agent outside a contact center premises. Incoming calls and facsimiles in some circumstances may also be routed through a gateway 103 into the Internet network 106 as packet-switched calls. The interconnections in the Internet are represented by backbone 121. In this circumstance such a call may be further processed as a packet-switched IP call. Equipment providing SCP services may also connect to the Internet and may allow SCP functionality to be integrated with Internet-connected servers and intelligence at contact centers.

A call from a land-line device 104 connecting to switch 102 may be routed to contact center 115 via trunk lines as shown to either a land-line switch 116 in contact center 115 or to a Traffic Processor 117. A contact center 115 may operate with the land-line switch or the traffic processor, but in some circumstances may employ both incoming paths. Traffic processor 117 may provide Session Border Control (SBC) functionality, may operate as a Media Gateway, or as a Softswitch.

Interactions through IP-enabled devices 108(1-n) may occur through the Internet network via backbone 121, enabled by a variety of service providers 105 which operate to provide Internet service for such devices. Devices 102(1) and 102(2) may be IP-enabled telephones, operating under a protocol such as Session Initiation protocol (SIP). Appliance 108(3) is illustrated as a lap-top computer, which may be enabled by software for voice communication over packet networks such as the Internet, and may also interact in many other ways, depending on installed and operable software, such as Skype™ or other VoIP solutions based on technologies such as WebRTC. Similarly appliance 108(n) illustrated as a desktop computer, may interact over the Internet in much the same manner as laptop appliance 108(3).

Many IP-enabled devices provide capability for users to interact both in voice interactions and text interactions, such as email and text messaging services and protocols. Internet 106 may include a great variety of Internet-connected servers 107 and IP-enabled devices with Internet access may connect to individual ones of such servers to access services provided. Servers 107 in the Internet may include email servers, text messaging servers, social networking servers, Voice over IP servers (VoIP), and many more, many of which users may leverage in interaction with a contact center such as contact center 115.

Another arrangement to interact with contact centers is through mobile devices, illustrated in FIG. 1 by devices 110, 111 and 112. Such mobile devices may include, but are not limited to laptop computers, tablet devices and smart telephones. Such devices are not limited by a land-line connection or by a hard-wired Internet connection as shown for land-line devices 104 or IP-enabled devices 108, and may be used by customers and agents from changing geographic locations and while in motion. Devices 110, 111 and 112 are illustrated in FIG. 1 as connecting through a wireless network 109, which may occur in various ways, e.g., through Wi-Fi and/or individual ones of cell towers 113 associated with base stations having gateways such as gateway 114 illustrated, the gateways connected to Internet backbone 121, etc.

In some circumstances mobile devices such as devices 110, 111 and 112 may connect to supplemental equipment operable in a moving vehicle. For example, cellular smartphones may be enabled for near-field communication such as Bluetooth™, and may be paired with equipment in an automobile, which may in turn connect to the Internet network through satellite equipment and services, such as On-Star™. Wireless communication may be provided as well in aircraft, which may provide an on-board base station, which may connect wirelessly to the Internet through either a series of ground stations over which an aircraft may pass in flight, or through one or more satellites.

Regardless of the variety of ways that Internet access may be attained by mobile devices, users of these devices may leverage Internet-connected servers for a great variety of services, or may connect through the Internet more directly to a contact center such as contact center 115, where users may interact as customers or as agents of the contact center.

Contact center 115, as described above, may represent one of a plurality of federated contact centers, a single center hosted by a single enterprise, a single contact center operating on behalf of a plurality of host enterprises, or any one of a variety of other arrangements. Architecture of an individual contact center 115 may also vary considerably, and not all variations may be illustrated in a single diagram such as FIG. 1. The architecture and interconnectivity illustrated in FIG. 1 is exemplary.

Equipment in a contact center such as contact center 115 may be interconnected through a local area network (LAN) 125. Land-line calls may arrive at a land-line switch 116 over trunk lines as shown from land-line network 101. There are a wide variety of land-line switches such as switch 116, and not all have the same functionality. Functionality may be enhanced by use of computer-telephony integration (CTI), which may be provided by a CTI server 118, which may note arriving calls, and may interact with other service units connected to LAN 125 to route the calls to agents connected to LAN 125, or in some circumstances may route calls to individual ones of remote agents who may be using any of land-line devices 104, IP-enabled devices 108 or mobile devices represented by devices 110, 111 or 112. The CTI server 118 can be implemented with a GENESYS TELECOMMUNICATIONS SYSTEMS, INC. T-server. Calls may be queued in any one of a variety of ways before connection to an agent, either locally-based or remote from the contact center, depending on circumstances.

Incoming land-line calls to switch 116 may also be connected to the interactive voice response (IVR) server 119, which may serve to ascertain a purpose of the caller and other information useful in further routing of the call to final connection, if further routing is needed. A router and conversation manager server 120 may be leveraged for routing intelligence, of which there may be a great variety, and for association of the instant call with previous calls or future calls that might be made. The router and conversation manager server 120 can be mapped to a GENESYS TELECOMMUNICATIONS SYSTEMS, INC. orchestration routing server, a universal routing server (URS) and conversation manager. The IVR 119 can also be used during outbound call campaigns.

Land-line calls thusly treated may be connected to agents at agent stations 127(1) or 127(2), each of which is shown as comprising a land-line telephone connected to switch 116 by directory number (DN) lines. Such calls may also be connected to remote agents using land-line telephones back through the land-line network. Such remote agents may also have computing appliances connected to contact center 115 for interaction with agent services such as scripting through an agent desktop application, also used by agents at agent stations 127(1-n).

Incoming calls from land-line network 101 may alternatively be connected in contact center 115 through Traffic Processor 117, described briefly above, to LAN 125. In some circumstances Traffic Processor 117 may convert incoming calls to SIP protocol, and such calls may be further managed by SIP Server 122.

Incoming calls from IP-enabled devices 108 or from mobile devices 110, 111 or 112, and a wide variety of text-based electronic communications may come to contact center 115 through the Internet, arriving in the Contact Center at an eServices Connector 130. eServices Connector 130 may provide protective functions, such as a firewall may provide in other architecture, and may serve to direct incoming transactions to appropriate service servers. For example, SIP calls may be directed to SIP Server 122, and text-based transactions may be directed to an Interaction Server 131, which may manage email, chat sessions, Short Message Service (SMS) transactions, co-browsing sessions, and more.

The Interaction Server 131 may leverage services of other servers in the contact center, and remotely as well. For example, SMS and email can be supported by a universal contact server 132 which interfaces with a database to store data on contacts, e.g., customers, including customer profiles and interaction history. The customer profile can include information about a level of service that the customer's interactions are to receive, e.g., for distinguishing a customer interaction (gold/silver/bronze) a particular interaction belongs to. The orchestration server 133 is the session-based routing component that takes core capability of routing and extends it, generalizes it, and integrates it with other components.

A workforce management server 135 of the contact center 15 can help manage the agent stations 127(1-n) to ensure the right resources are in place at the right time to handle customer interactions and work items that the Interaction Server 131 sends to the agent stations 127(1-n), in an appropriate way. The orchestration server 133 can assign interactions and other work items to agents. The workforce management server 135 can schedule agents for activities, e.g., schedule an agent to process email on mortgages from 1-2 pm on Wednesdays. The workforce management server 135 helps ensure that agents that are skilled at handling the particular types of interaction (e.g., voice, email, chat, web, etc.) are available at the right times so that the enterprise can provide a good experience for the customers. The workforce management server 135 can provide for forecasting, scheduling and tracking to get the most from available agents, e.g., based on service level objectives, employee contracts and preferences.

An analytics server 137 of the contact center 15 can include one or more processors, e.g., for interaction recording, e.g., between customers and agents, speech, text, chat, etc. analytics, and quality management, etc. In one example, the analytics server 137 can analyze recorded interactions with contact center agents to classify the recorded interactions and generate evaluation forms based on the interactions.

Agent station 127(3) is illustrated as having a connected headset from a computing device, which may execute telephony software to interact with packet switched calls. Agent station 127(n) is illustrated as having an IP-enable telephone connected to LAN 125, through which an agent at that station may connect to packet-switched calls. Every agent station may have a computerized appliance executing software to enable the using agent to transact by voice, email, chat, instant messaging, and any other communication process.

A statistics server 124 is illustrated in contact center 115, connected to LAN 125, and may provide a variety of services to agents operating in the contact center, and in some circumstances to customers of the contact center. Statistics may be used in contact center management to vary functionality in routing intelligence, load management, and in many other ways. A database dB may be provided to archive interaction data and to provide storage for many of the activities in contact center 115. An outbound server 123 is illustrated and may be used to manage outbound calls in the contact center 115, where calls may be made to aid the authentication process, and answered calls may be connected directly or be queued to be connected to agents involved in the outbound calls.

As described above, contact center 115, and the architecture and connectivity of the networks through which transaction is accomplished between customers and agents is exemplary, and there are a variety of ways that similar functionality might be attained with somewhat different architecture. The architecture illustrated is exemplary.

Contact centers 115 may operate with a wide variety of media channels for interaction with customers who call in to the centers. Such channels may enable voice interaction in some instances, and in other instances text-based interaction, which may include chat sessions, email exchanges, and text messaging, etc.

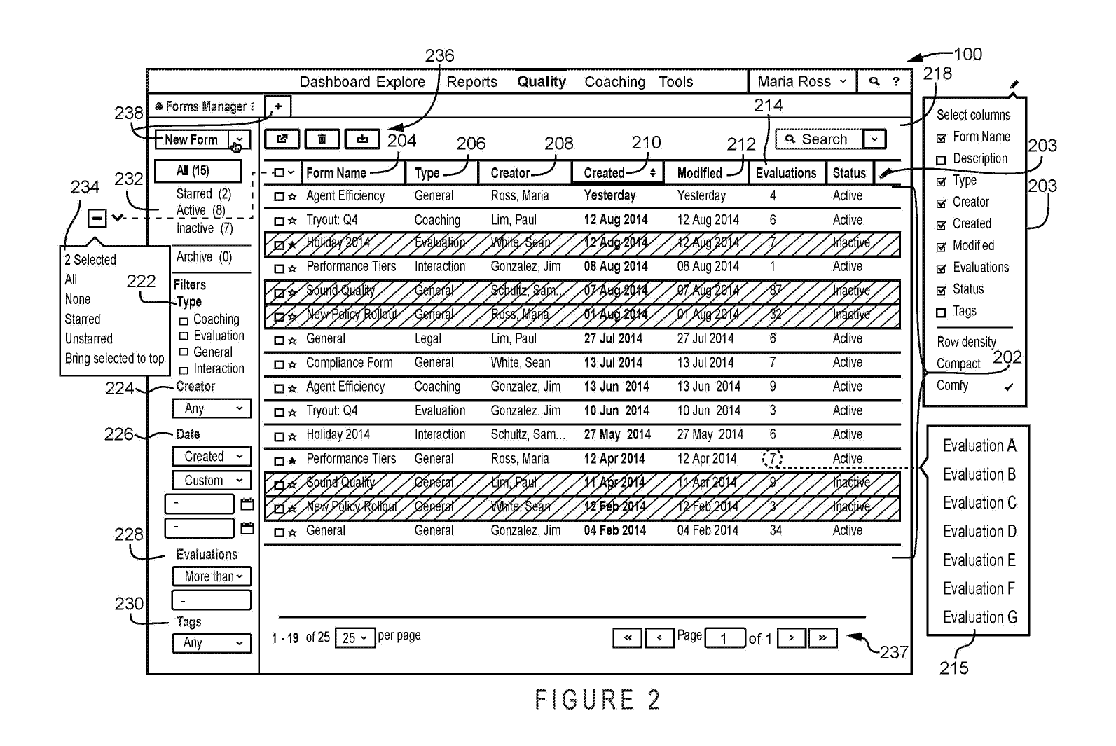

FIG. 2 is a screenshot of an example user interface screen for a forms manager 100 of the quality management platform. The screenshots described herein can include screenshots from a web browser executing on a computer, smart phone, tablet, etc. The forms manager 100 lists the built forms 202. The forms 202 can be identified by headings which can be added or removed using an edit button 203, and include form title 204, description, type 206, creator 208, date created 210, date modified 212, number of evaluations 214, status 216, and tags, etc. The form type 206 can include general, coaching, evaluation, interaction, legal, etc. For example, legal formal can track if one or more of the agent stations 127(1-n) are providing the customers with the proper disclaimers, following the rules, etc. The status 216 can include active or inactive, etc. A search field 218 can allow the forms manager 100 to search keywords for text field. The drop down part of the search field 218 can enable search by column.

The forms manager 100 can search for forms with a filter, including by type, e.g., coaching, evaluation, general and interaction, by creator 224 to identify a creator of the form, by date 226, e.g., a date of creation or date of modification of the form, an evaluations input 228, e.g., by number of evaluations, e.g., fewer than, more than or exactly, and by tags 230, e.g., which can help identify the forms. Quick filters can be used, including for starred, active, inactive and archived forms. Drop down 234 can be used to select all, none, starred and un-starred forms. Selected forms can also be brought to a top of the page. Additionally, evaluations 214 can be viewed via an evaluations list 215 by clicking on the number showing the current number of evaluations in the evaluations column. The completed evaluations can be viewed by clicking on an evaluation name in the evaluation list 215. A form 202 can be viewed by clicking on the row of the form, which can open the form 202 as a separate tab.

An open, delete and archive set of buttons 236 perform the selected action on a highlighted row or rows of forms 202. Additionally, pagination buttons 237 can set the number of forms 202 to show per page, move to a beginning of the list of forms 202, move to an end of the list of forms 202, move page-by-page forwards or backwards, etc. The forms manager 100 can also provide an input 238 to create a new form. In response to create a new form input 238, the form manager 100 can build forms as a custom form or a template. In one example, the forms manager creates forms ad hoc as an evaluator is listening to a call. Additionally or alternatively, the evaluator can leave feedback about the agent 127(1-n) on a question basis and/or general feedback. The feedback can be stored as part of a history of an agent 127(1-n). The feedback can also be used to produce questions for future forms for the agent, e.g., specific questions related to the agent's tone, the way they state the policy and the way they greet the customer, etc. These questions can aid in coaching objectives for the agent. The additional questions can be temporarily added for a determined time, permanent, updated based on agent performance, etc.

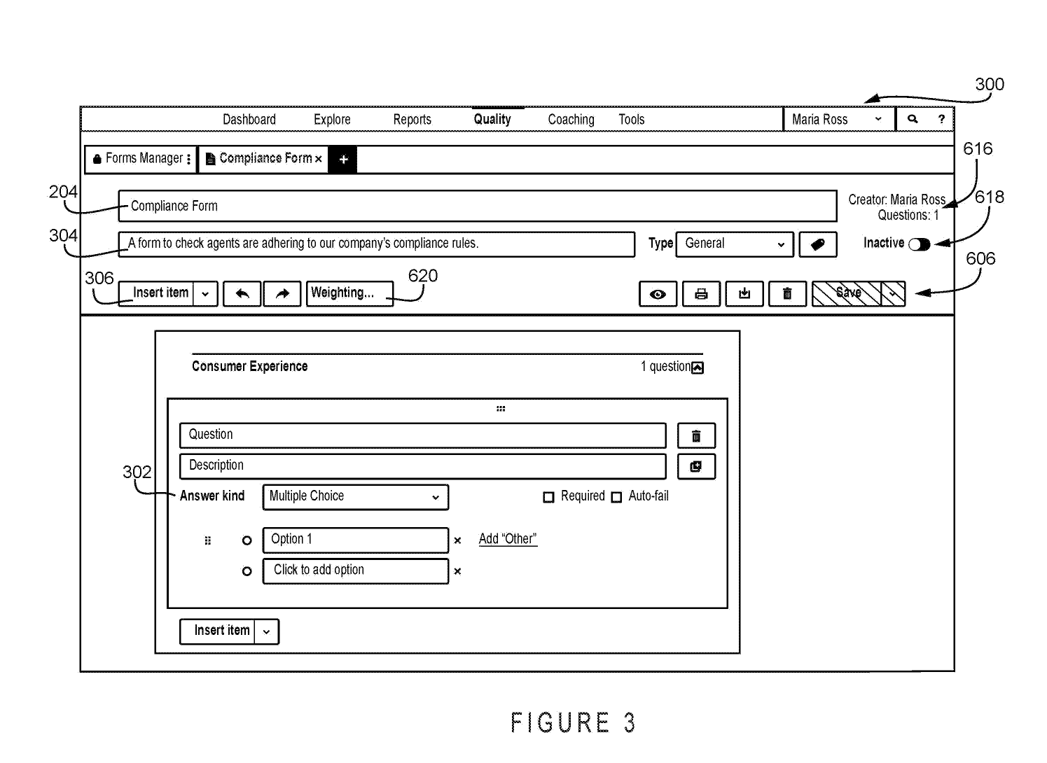

FIG. 3 is a screenshot of an example form template 300 for building a form 202. For explanation purposes a consumer experience compliance form is illustrated. The forms manager 100 can provide a selection of answer types 302, e.g., group, yes/no, multiple choice, choose from a list, free form, sliding scale, choose from a library, etc. The selected options can be picked from a drop-down menu. For example, question can be stored in a library for re-use in a variety of forms. Different departments may wish to use the same questions on its forms. When the question is selected, the form manager 100 can include an insert item button 306 to insert the question into the form. To help identify the form, in addition to the title 104 a short description 304 can be included, e.g., ‘A form to check agents are adhering to our company's compliance rules.’

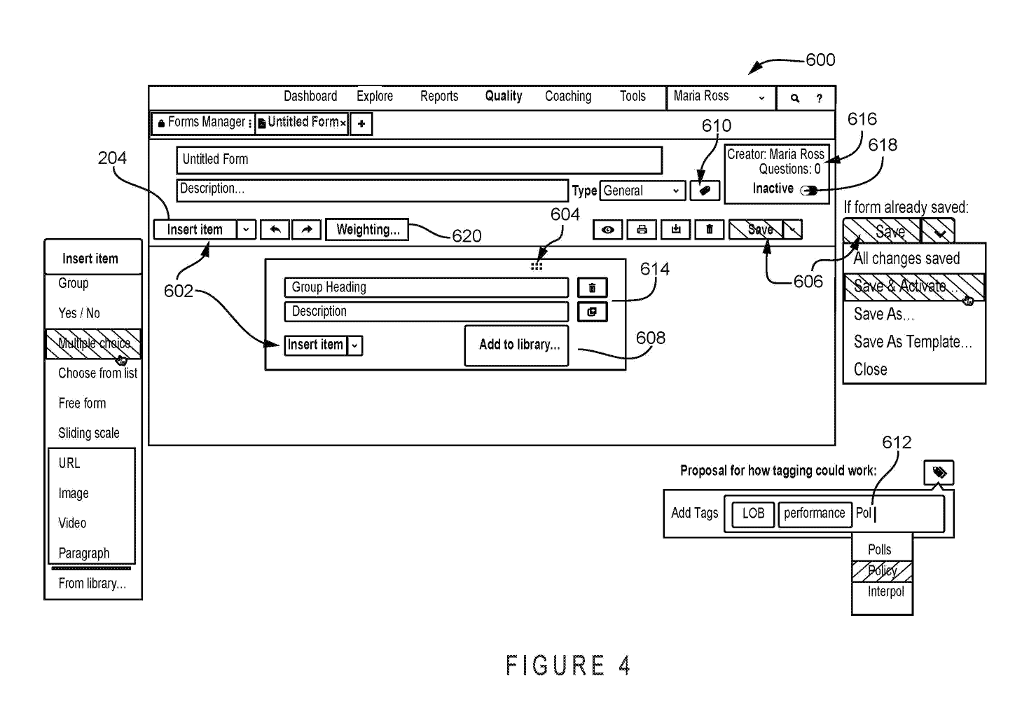

FIG. 4 is a screenshot of an example of an interface 600 for building the form 202. In one example, the forms manager 100 can build items into a form by a click of the ‘insert an item’ button 602, e.g., by group of questions, yes/no questions, multiple choice questions, choosing questions from a list, free form drafting of questions, sliding scale questions, and inserting universal resource locator (URL), images, videos, paragraphs, and question from library, etc. The insert an item button 602 can appear in one or more areas of the screen, for example, at a top of the screen, at a bottom of the screen, immediately below a previous question, etc., to allow access to the insert an item button 602, even when the screen is being scrolled.

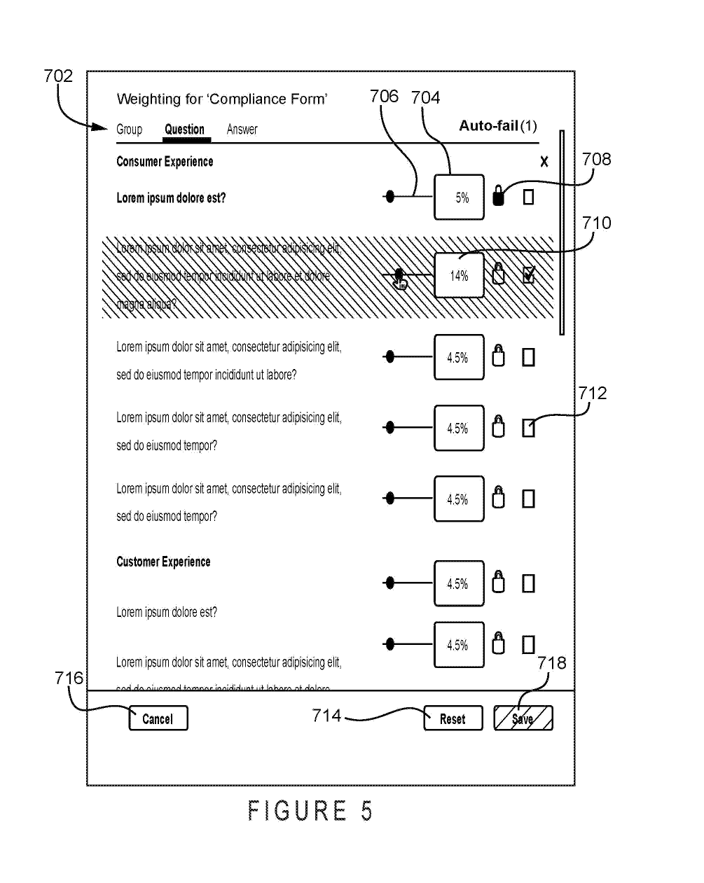

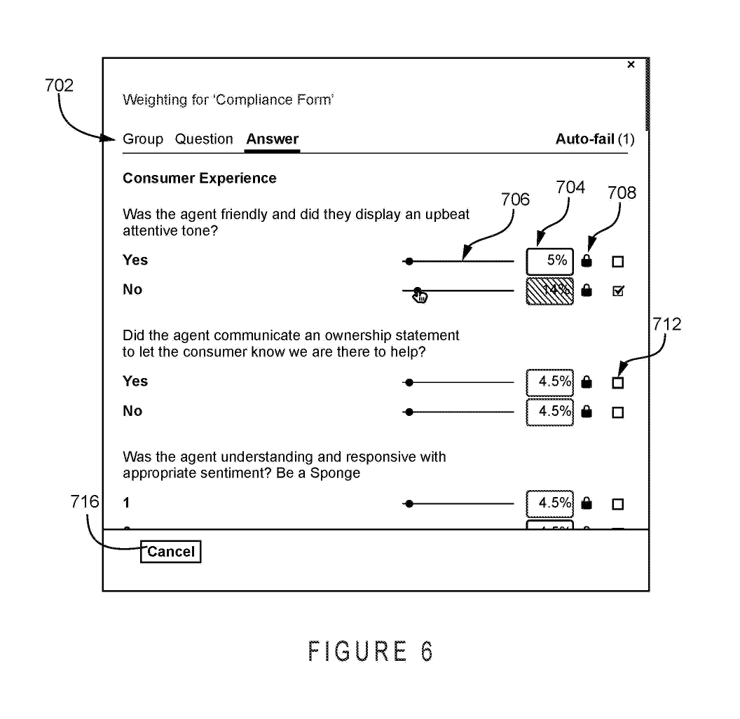

The interface 600 can include a grabber tool 604 to pick up and re-order items within the form. A tool bar 606 can provide buttons to preview the form, print the form, archive the form, delete the form, and save the form, etc. The interface 600 can add groups of questions to the library, e.g., using an add-to-library button 608, which can bring up an edit library item dialog. The interface 600 can categorize and organize forms by types or tags 610. The input 612 for the tags can predict a desired tag from a pool of possible tags as the tag is written. Other buttons 614 can provide trash, clone groups and add questions, etc. The interface 600 can display creator and question metadata 616, and a button 618 can activate or lock the form. The forms manager 100 can provide for the adjusting of weighting of questions, via a weighting button 620, e.g., as described in FIGS. 5 and 6.

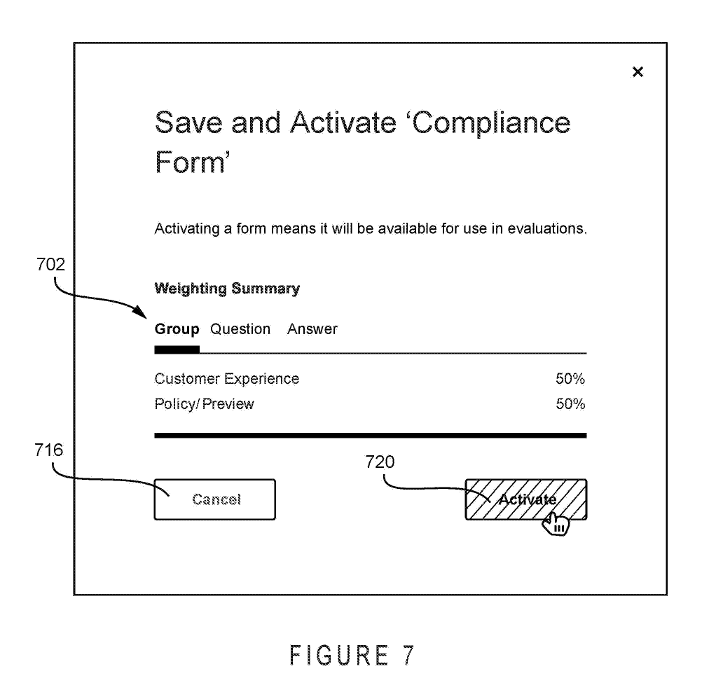

FIGS. 5-7 are screenshots of an example user interface screen for weighting questions, answer and group, respectively. The forms manager 100 can provide selection buttons 702 to weight the forms 202 by group, question, answer, etc. The weights can be entered as a percentage value or other weight indicator 704, for example. The forms manager 100 can provide a slider bar 706 to adjust the weight and/or the weight can be entered as a text value. If entered as a percentage, the weights for the various groups, questions and/or answers can be linked to add up to 100%. Therefore, if a weight for one group, question or answer is changed, weights for the other groups, questions or answers are automatically adjusted. Additionally, a weight can be locked 708 to break a dependency on other weight values. The weight being adjusted can be highlighted 710. The forms manager 100 can provide auto-fail check boxes 712. A reset button 714 can reset the weights to even distribution or other defined default weight. The forms manager 100 can also provide a cancel button 716 to cancel any changes to the form 202 and a save button 718 to save changes. Clicking the activate button 720 makes the form 202 available for use in evaluations.

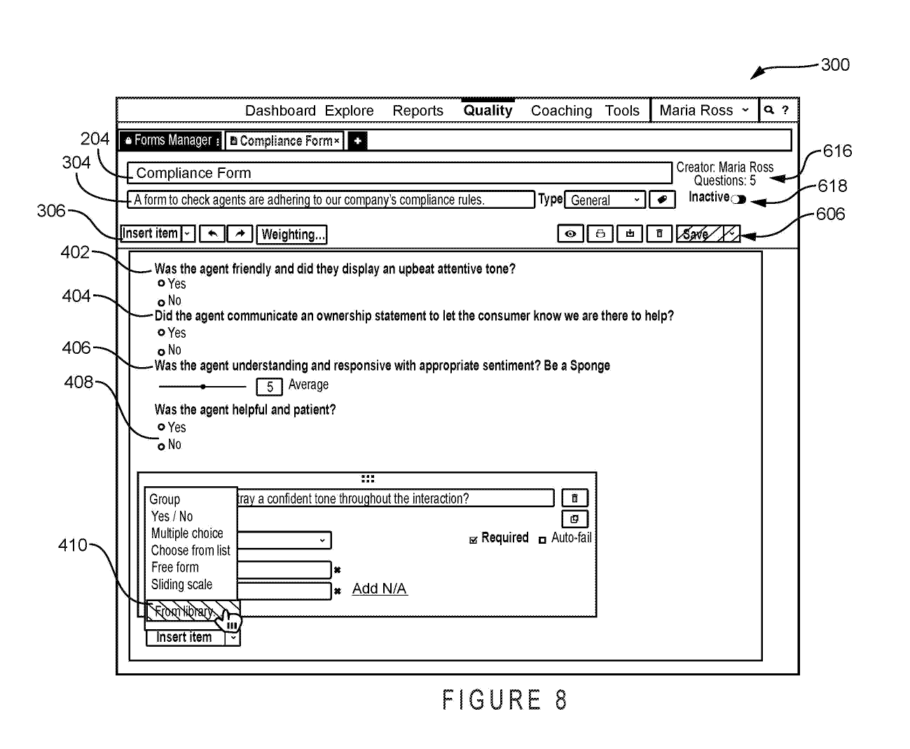

FIG. 8 is another screenshot of the form template 300, e.g., to build or edit a form 202. As the forms manager 100 builds and edits the form 202, various types of questions can be included. For example, the form can include a first yes/no question 402, a second yes/no question 404, a slider question 406, and a third yes/no question 408, etc. The next question for the form manager 100 to add can be obtained from the library 410. The questions can be set up as conditional so that they populate or not depending on depending on an answer to a previous question. For example, if yes was answered to an upsell question, a follow-up question related to the upsold service or product can appear.

Other questions can be presented or not depending on other factors, e.g., based on voice analytics, chat analytics, etc. For example, if the analytics server 137 determines that an event happens during the call that matches the tag 612, e.g. cancelling an account, a group of questions, sometimes referred to as conditional questions, related to a cancelled account can be presented. Additionally or alternatively, determining interactions to present the questions can be determined by speech analytics. For example, if speech analytics recognizes that the person during the call was upset, questions can be sent to the caller, versus purely random call selection. The speech analytics can also determine if the agent 127(1-n) identified themselves properly to the caller, presented the correct legal disclaimers, etc., and appropriate questions can be sent.

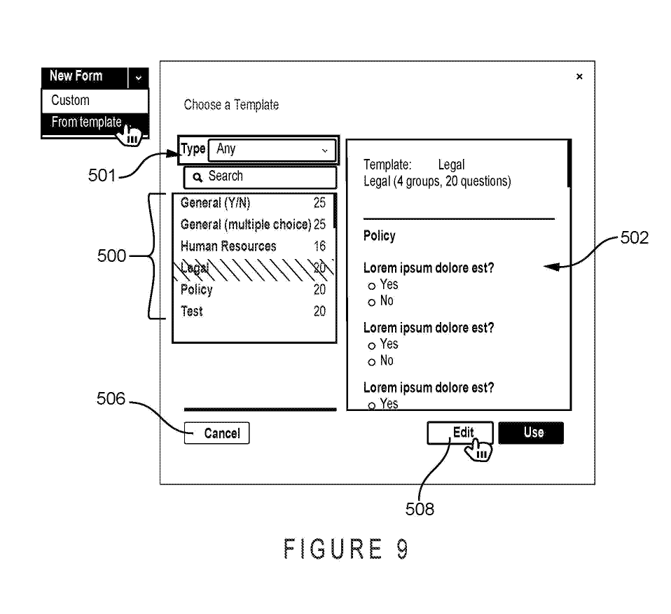

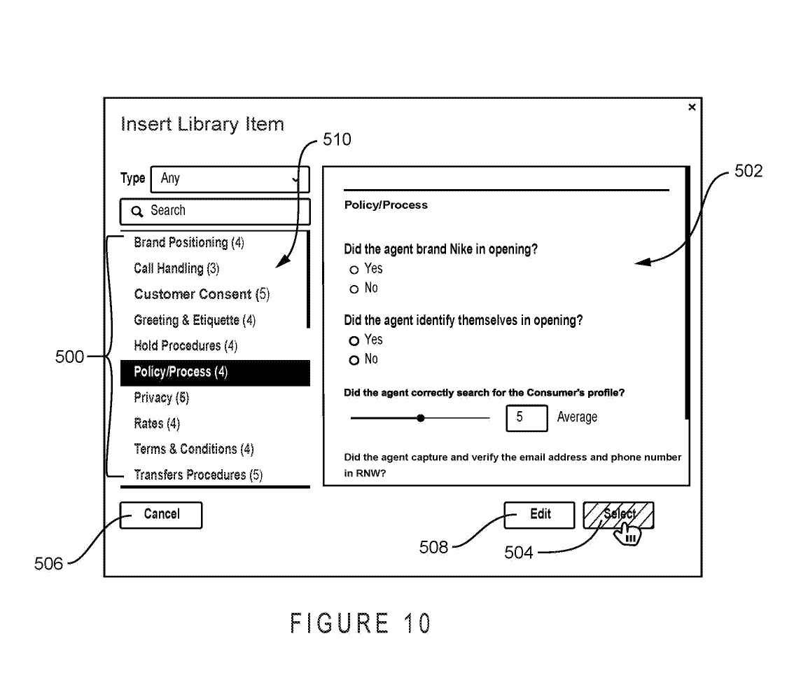

FIGS. 9 and 10 are screenshots of an example user interface screen for inserting a library item to the form 202. The library item can provide question groupings 500, e.g., by topic, e.g., type of form 501. Example topics for library questions include general yes/no, general multiple choice, human resources, legal, policy, test, etc. Example topics for policy/process questions include brand positioning, call handling, customer consent, greeting and etiquette, hold procedures, policy/process, privacy, rates, terms and conditions, transfers procedures, etc. A number of questions provided in the question groupings 500 can be indicated near the topic identifier. The questions for the topic can be displayed next to the topic identifiers, e.g., in area 502, for a preview of the questions related to the highlighted topic identifier. The determined group of questions can be selected by pressing a select button 504, or selection can be cancelled by pressing a cancel button 506. In some cases the library item may be edited 508. Editing a library group may break the link to the library item, and a warning can be given, e.g., with a pop-up screen, to confirm the break. Additionally or alternatively, some library items may be locked, e.g., un-editable.

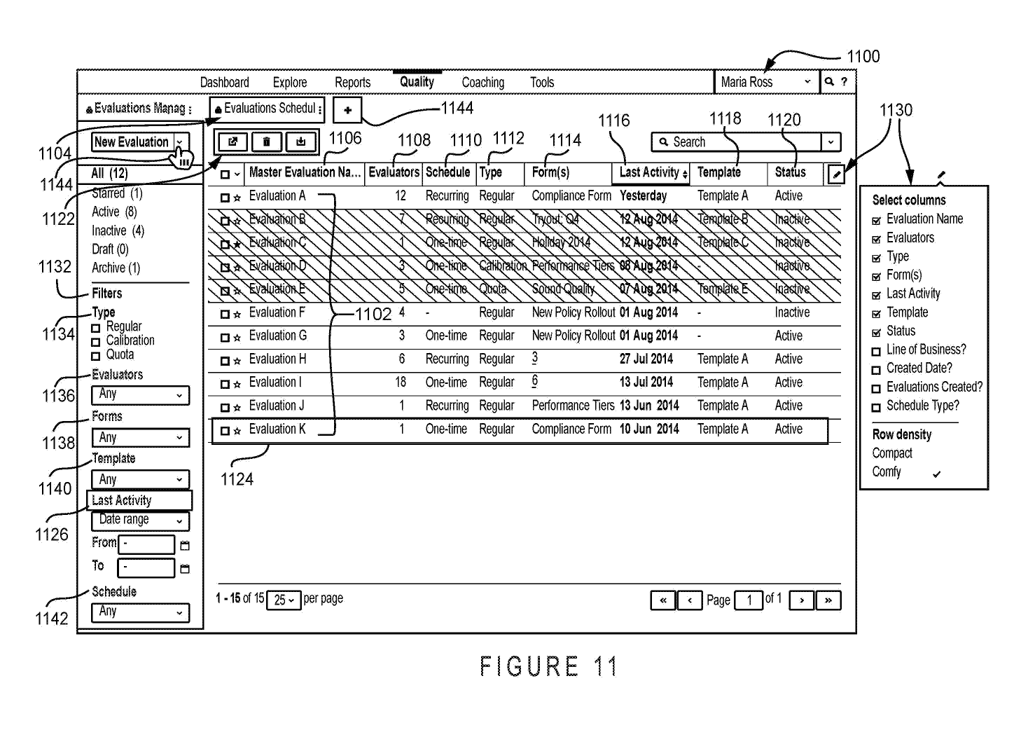

FIG. 11 is a screenshot of an example user interface screen 1100 for an evaluations manager of the quality management platform. The evaluations manager can schedule evaluations 1102 to occur one-time or as recurring evaluations. A schedule icon 1104 can be used to determine a frequency of the evaluation, e.g., one time, every day, every week, every month, etc., and display evaluation states, e.g., pending, ongoing, or complete. The evaluations manager can base a frequency of evaluation on how well the agent 127(1-n) has been performing on evaluations, e.g., based on a determined score threshold for the evaluation. To help save on resources, better performing agents 127(1-n) can be scheduled for evaluation less often than agents 127(1-n) whose scores do not meet the threshold, for example. Additionally or alternatively, the schedule icon 1104 can be connected with a workforce management system to ensure that reviewed evaluations occur on days that the agent 127(1-n) is working, e.g., so that the agent (1-n) can meet with the evaluator for feedback. Additionally or alternatively, evaluation frequency can be based on customer survey feedback. For example, if a customer was not satisfied with a call for a determined agent 127(1-n), a frequency of evaluations can increase.

The evaluations 1102 can be identified by name 1106, number of evaluators 1108, schedule 1110, e.g., recurring or one-time, type 1112, e.g., regular, calibration or quota, forms 1114, e.g., compliance, tryout, holiday, performance tiers, sound quality, new policy rollout, etc., last activity date 1116, template identification 1118 and status 1120, e.g., active or inactive, etc. Other examples include evaluations that are correlated by agent learning curve, time of day, voice quality, etc.

Action buttons 1122 can open, delete and archive highlighted evaluations 1102. In one example, an active evaluation 1124 may not be deleted. The active evaluations 1124 can be edited but their generated evaluations may only update at a next scheduled time. The edit table button 1130 can be used to select columns to display, e.g., evaluation name, evaluators, type, forms, last activity, template, status, line of business, created date, evaluation created, schedule type, and/or to set row density, e.g., compact, comfy, etc.

The evaluations manager can search for evaluations, e.g. by filters 1132, including type 1134 of evaluation, evaluator name 1136, type of forms 1138, type of template 1140, last activity 1126, and schedule 1142 of evaluations. A last activity 1126 can reflect a time period to display for a last edited, last scheduled run, etc. The evaluations manager can provide the list of evaluations 1102 based on the inputted filters 1132. The evaluations manager can include a first or second create evaluation button 1144 can be used to create a new evaluation.

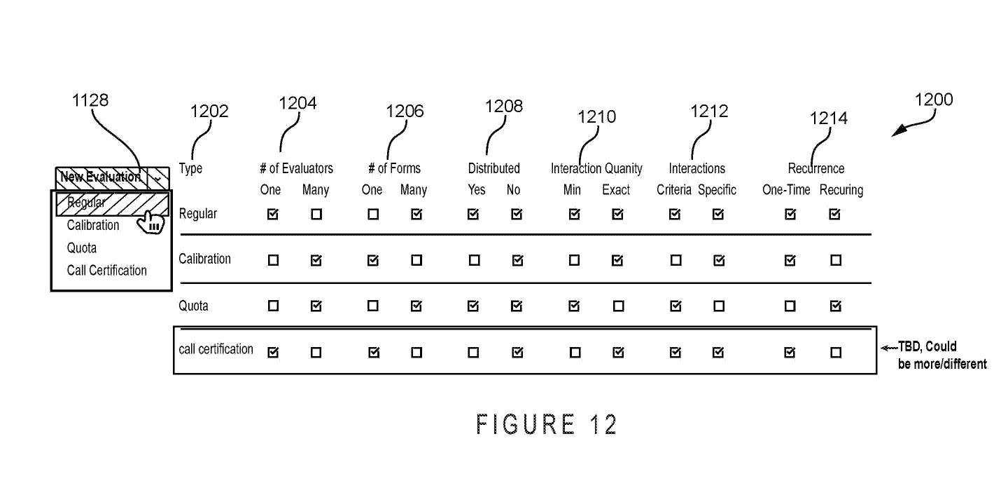

FIG. 12 is screenshot of an example matrix 1200 of evaluation types for creating an evaluation. The create evaluation button 1128 can provide a drop down menu of evaluation type 1202 options, e.g., regular, calibration, quota and call certification, etc. Regular evaluations include that the quality assurance (QA) team should complete a determined number of evaluations within a determined time period, e.g., 200 evaluations in a month. Interactions to be evaluated can be selected at random throughout the month. Calibration evaluation includes a determined number of evaluators evaluating a determined interaction, as described in more detail below. Quota includes that a QA team should handle a determined number of evaluations without a determined time period. Call certification includes evaluating the first determined number of calls by the agent 127(1-n) after the training period ends, e.g., to determine if the agent 127(1-n) is hired or not.

For the types 1202 of evaluation, the number of evaluators 1204 can be selected, e.g., one or more. The number of forms 1206 for the evaluation can be selected as one or more. The evaluation manager can control whether or not the evaluation is distributed 1208, the interaction quantity 1210, e.g., minimum or exact, criteria or specific interactions 1212, and whether there is a one time or more recurrence of the evaluation.

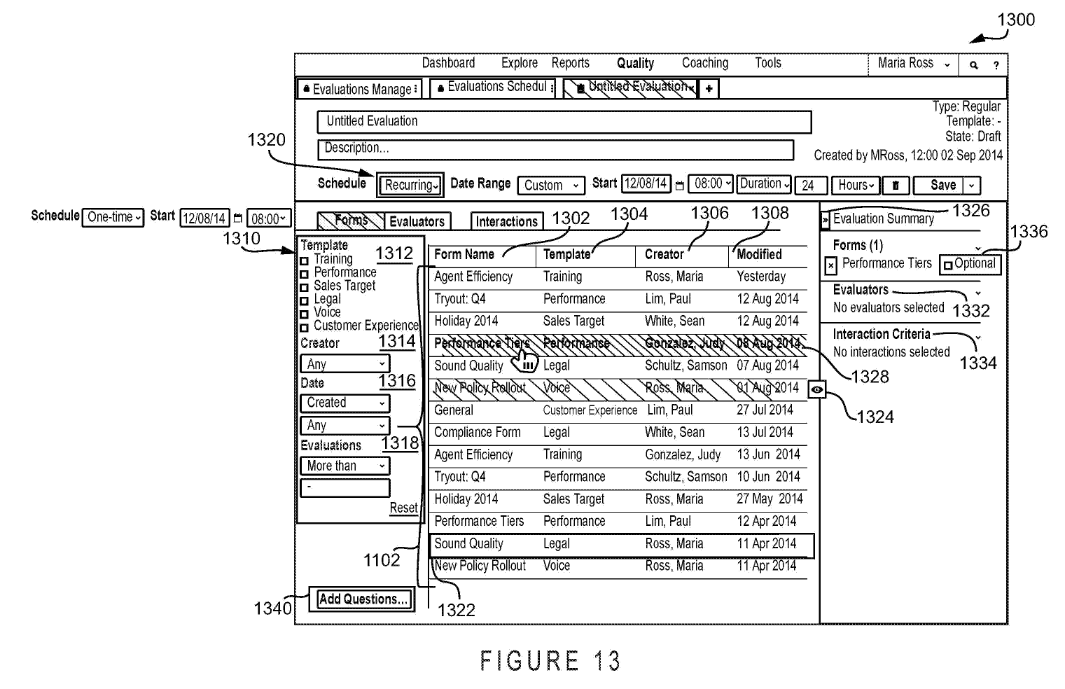

FIG. 13 is a screenshot of an example user interface screen 1300 for managing evaluations 1102. The evaluation manager can display evaluations 1102 on the screen 1300 and show the form name 1302, template type 1304, creator 1306, date modified 1308, etc. The evaluation manager can display the evaluations 1302 based on a filter 1310, e.g., by template 1312 (training, performance, sales target, legal, voice, customer experience, etc.), creator 1314, date 1316, evaluations 1318, etc. The evaluations can be scheduled 1320, e.g., as set by drop down options including a one-time occurrence or recurring. Clicking 1322 on the evaluation adds the form to an evaluation summary palette. The evaluation form can be previewed in a modal window by hovering on the listed form and clicking on a displayed eye icon 1324.

The analytics server 137 can determine when to perform an evaluation on the agent, e.g., based on an agent's schedule. In this way the analyst can perform the evaluation and provide coaching to the agent when the agent is working so that the evaluator can give feedback while the evaluation is fresh in their mind. The feedback can include how well the agent answered the customer's questions. If the agent is working from home, the analytics server 137 can determine whether a level of background noise is within an acceptable level or not. The forms manager can generate a specific question or group of questions regarding background noise if the background noise was above a determined threshold, e.g., the environment was noisy because the agent works from home.

The analytics server 137 can also determine with speech analytics, text analytics, chat analytics, web analytics, email analytics, etc. a conversation level, e.g., if the agent is not a native speaker and the customer does not understand the agent, if the agent curses, etc. The analytics server 137 can also determine a content of the interaction using analytics. Therefore, the contact center 15 can perform an evaluation based on the content of the interaction, the conversation level, the agent' communications, the customer's communications, call data, etc. The forms manager can add specific questions to the evaluation form based on the interaction data, timing of the interaction and/or other criteria, for example questions about an understanding level or customer comprehension of the interaction if the agent is not a native speaker. Additionally, specific questions can be added if the interaction took place within a determined time of a big even, e.g., the Super Bowl. The contact center 15 can conduct an immediate follow-up call to the customer if the analytics server 137 and/or evaluator determine that the customer was unsatisfied with the interaction. Feedback can also be provided to the Interaction Server 131 for outbound campaigns. Additionally or alternatively, the contact center 15 can perform other actions, e.g., coaching the agent, firing the agent, reassign the agent, sending the agent to human resources (HR), etc.

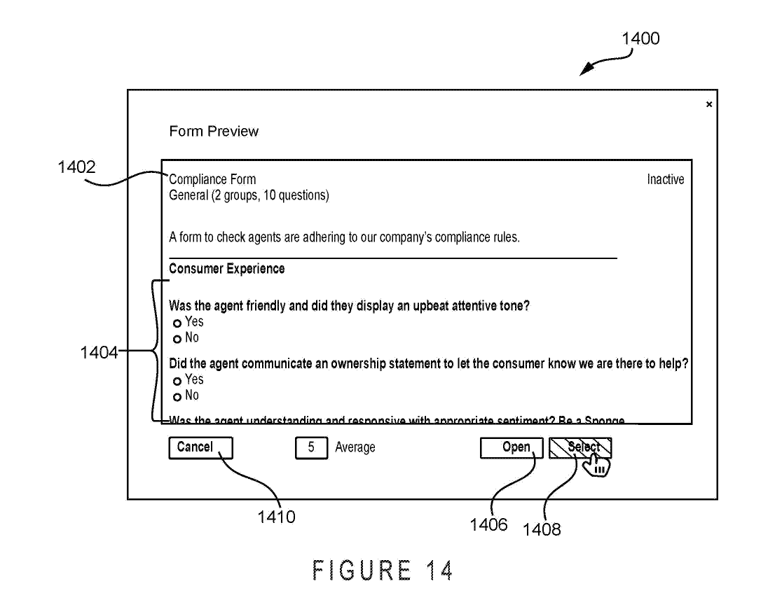

FIG. 14 is a screenshot of an example form preview interface screen 1400. The preview interface screen 1400 can display the type of form 1402, including the number of groups associated with the form and number of questions. The preview interface screen 1400 can display the questions 1404. The preview interface screen 1400 can also provide option buttons including opening 1406 the form, selecting 1408 the form and cancelling 1410 the preview.

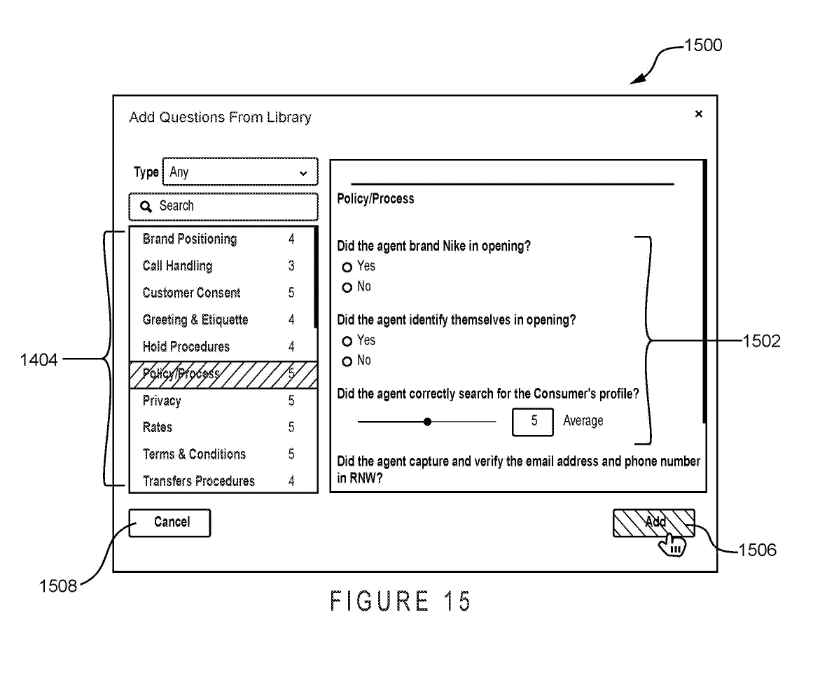

In FIG. 13, the screen 1300 can display or minimize an evaluation summary 1326 which summarizes information about a highlighted form 1328 including evaluators selected 1332 and interaction criteria 1334, and provides the ability to remove 1330 a selected form from the list. The highlighted form 1328 can be designated as optional 1336 when more than one form is selected. The interface screen 1300 can also provide a button 1340 to independently add questions to a form, e.g., as displayed in FIG. 15.

FIG. 15 is a screenshot of an example interface screen 1500 to add questions to the evaluations 1102. Questions 1502 can be grouped by type 1504 of question, e.g., brand positioning, call handling, customer consent, greeting and Etiquette, hold procedures, policy/process, privacy, rates, terms and conditions, transfer procedure, etc. To display questions 1502, the type 1504 of question can be highlighted. An add button 1506 can add selected questions 1502 to the evaluations. A cancel button 1508 can cancel the add interface screen 1500 and return to the interface screen 1300 (FIG. 13) for managing evaluations 1102.

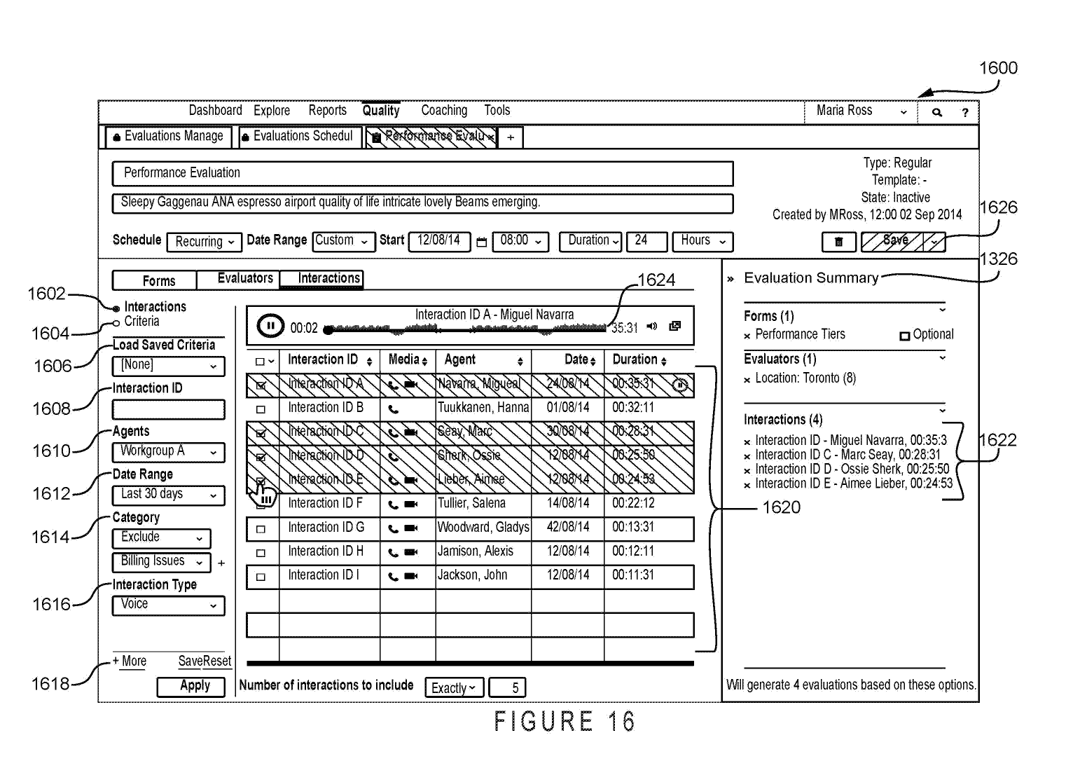

FIG. 16 is a screenshot of an example interface screen 1600 to generate evaluations based on selected interactions 1602 and/or criteria 1604. Interactions enables the evaluation manager to provide evaluations by specified interactions as opposed to criteria. Criteria allows selection by loaded saved criteria 1606, e.g., an incident number, interaction ID 1608, e.g., via an advanced drop down, agents 1610, e.g., workgroup A, date range 1612, category 1614, interaction type 1616, etc. Buttons 1618 can provide to add more criteria, save the criteria, reset the criteria to factory set criteria, etc. The interface screen 1600 can display selected interactions 1620 and highlighted interactions 1622 can be listed in the evaluation summary 1326. The evaluation manager for the interface screen 1600 can generate evaluations based on the selected options. The interactions 1620 can be played 1624, e.g., the analytics server 137 recorded voice and or video of the interaction.

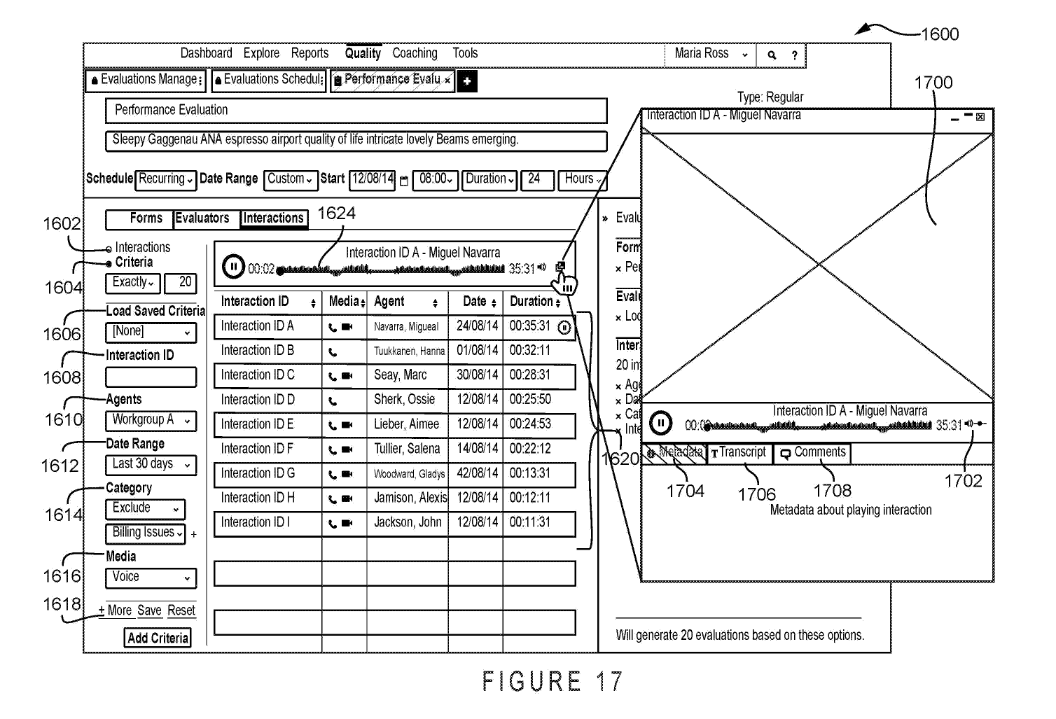

FIG. 17 is a screenshot of an example video display 1700 of the interface screen 1600. In addition to video, the video display 1700 can display the sound track 1702, metadata 1704, transcripts 1706, comments 1708, etc. As best shown in FIG. 16, a save button 1626 can include a dropdown list of options to save and activate the evaluation, save the evaluation as a determined file name, close the evaluation, etc.

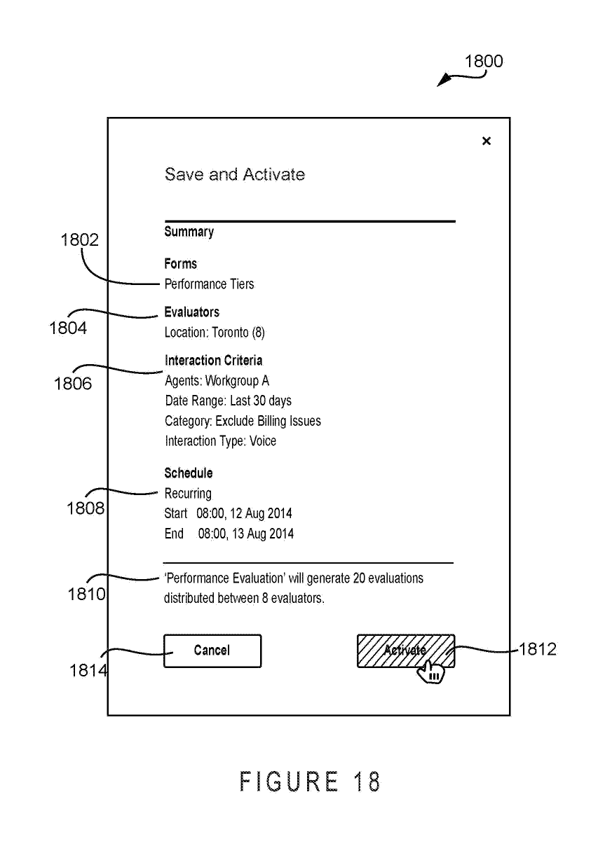

FIG. 18 is a screenshot of an example save input screen 1800 for the evaluations 1102. The save input screen 1800 can include a summary of the saved evaluation 1102, including form description 1802, evaluators 1804, interaction criteria 1806 and schedule 1808. Interaction criteria can include a description of the agent or agents being evaluated, e.g., workgroup A, date range, e.g., last 30 days, category, e.g., exclude billing issues, and interaction type, e.g., voice. The summary can include a description of the type of evaluation, the amount of evaluations being generated and the number of evaluators that the evaluations are being distributed to 1810. An activate button 1812 is provided to active the evaluations and a cancel button 1814 can cancel the evaluations.

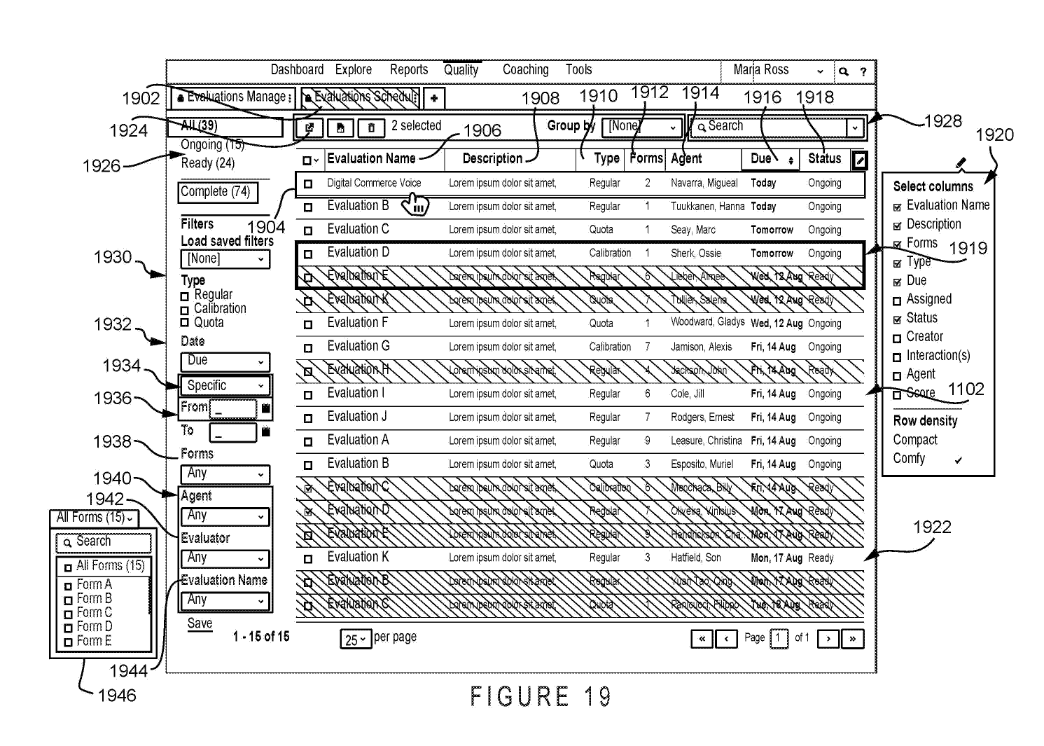

FIG. 19 is a screenshot of an example evaluations schedule 1900 for completing evaluations. The tab 1902 can provide access to the evaluations schedule 1900. A click 1904 on a row opens the evaluation 1102 for that row. The evaluations 1102 can be identified by evaluation name 1906, description 1908, type 1910, forms 1912, agent 1914, due date 1916, status 1918, etc. Different row background colors 1919 can also denote the status 1918, e.g., ongoing where evaluations have been started and saved but not yet completed, ready where evaluations have been assigned but not yet started, etc. An edit table tab 1920 can set the row density and columns to be displayed. Other column identifiers include assigned, creator, interaction(s), agent, score, etc. Rows can be selected 1922 for determined functions, e.g., using tabs 1924 to open, run reports, send to trash based on permission, organized by grouping, etc.

Status indicators 1926 can indicate a number of evaluations 1102, a number of evaluations that are being worked on (ongoing), a number of evaluations 1102 that are read to be evaluated, a number of evaluations that are completed, etc. A search field 1928 can provide keyword searches for the text in the evaluations schedule 1900, and can provide a dropdown to search by column. The evaluations schedule 1900 can be used to filter the evaluations 1102, e.g., by type 1930, by date 1932, e.g., assigned/due 1934 or tomorrow/next 7 days/month/custom 1936, by form type 1938, by agent 1940, by evaluator 1942, by evaluation name 1944, with an advanced word search 1946, etc.

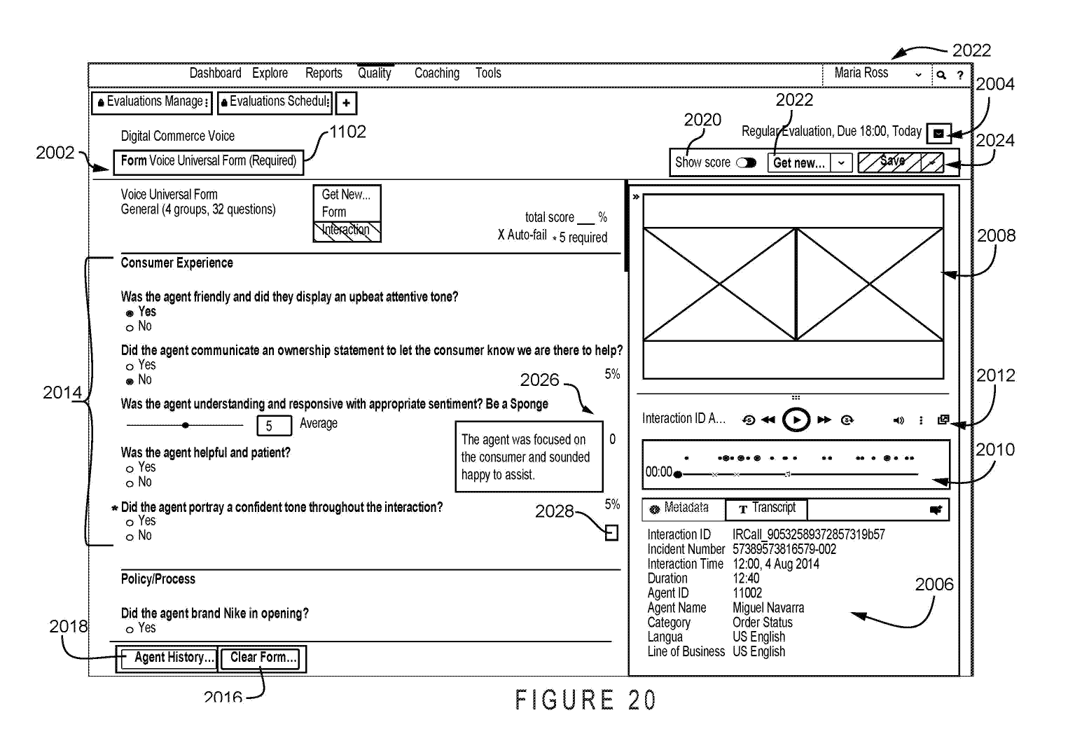

FIG. 20 is a screenshot of an example screen 2000 for an open evaluation 1102. The screen 2000 can include a field 2002 to display the form name for the evaluation 1102, which can become a dropdown if there is more than one form. When changing to a different form, the screen 2000 can auto-save the answers of the form that are already filled in. Metadata 2004 can be displayed including evaluation type and due date, and other dropdown or popover information can be displayed including description of the interaction being evaluated, name of the person assigning the evaluation, name of evaluator and name of evaluee. The screen 200 can also display additional metadata 2006 regarding the interaction, including an interaction ID, interaction time, duration of the interaction, agent ID, agent name, program and language.

The screen 2000 can display video 2008 and/or audio 2010 of the interaction being evaluated. The screen 2000 can also display other parts of the interaction, including emails, texts, etc. Media player buttons 2012 can control the video and audio playback, including play, pause, stop, forward, rewind, etc. The media player can be expanded from a mini media player in the evaluation workspace to a full-screen media player, e.g., displayed over multiple monitors. In other example, the media player can also be dragged to other parts of the screen 2000. Based on the interaction the evaluator can answer the questions 2014. The screen 2000 can clear the answers if the clear form button 2016 is engaged. The screen 2000 can also display past evaluation scores and notes if the agent history button 2018 is engaged. The screen 2000 can also show or not show the current score 2020 as the evaluator completes the evaluation, get a new form or interaction 2022, and/or save 2024 the form. The screen 2000 can give a warning if the evaluation is saved before the evaluation is completed and highlight the questions and/or forms that still need to be answered. The screen 2000 can also display a question description 2026. The screen 2000 can also display a notes icon 2028 to click to provide/display notes.

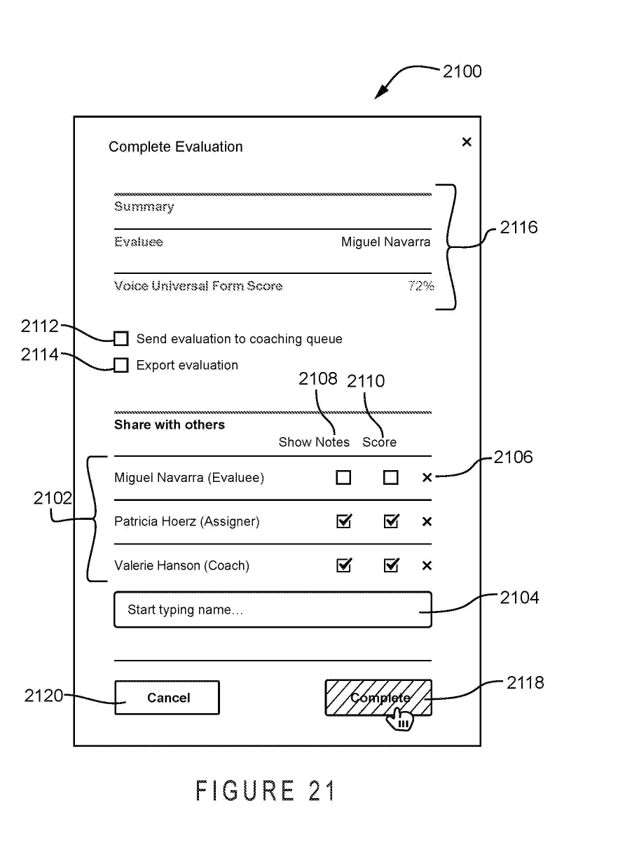

FIG. 21 is a screenshot of an example screen 2100 for sharing an evaluation 1102. In one example, the evaluation 1102 can be shared for calibration purposes, as described below. In another example, a completed evaluation can be shared for review. The screen 2100 can provide a list 2102 of people that are to receive the evaluation. Names on the list 2102 can be added 2104 and removed 2106. Notes and scores can be shared or not depending on if the note box 2108 and the score box 2110 are checked. The evaluation can be sent to a coaching queue if a box 2112 is checked, and exported, e.g., to WORD or EXCEL, is box 2114 is checked. The screen 2100 can display data 2116 including a summary, evaluee name and score. Sharing of the evaluation can be completed 2118 or cancelled 2120.

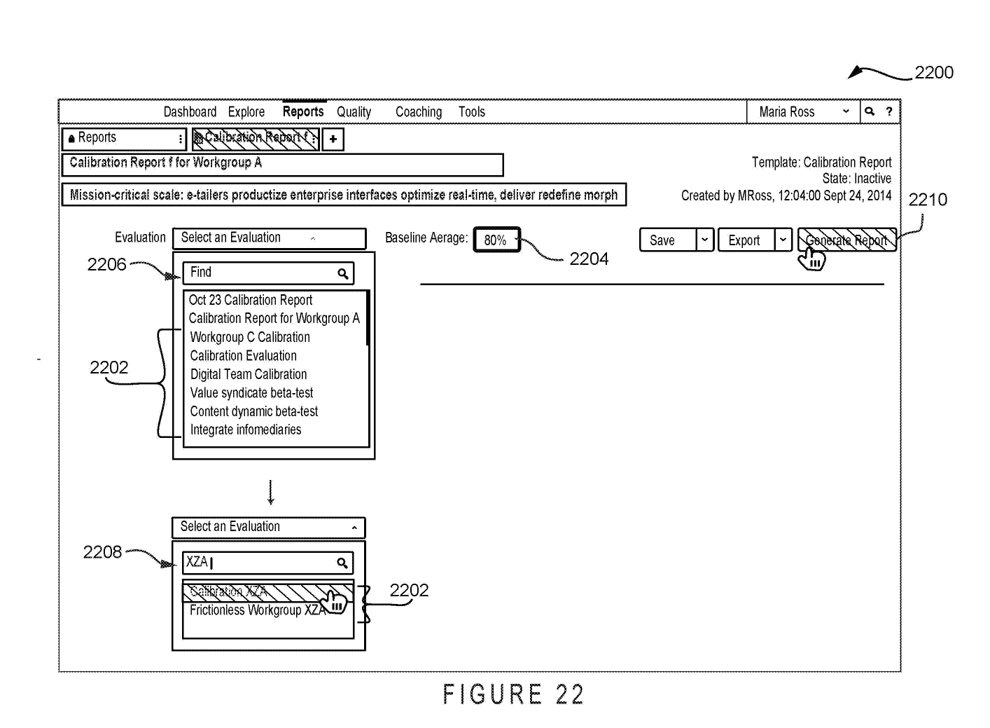

FIG. 22 is a screenshot of an example screen 2200 for generating calibration reports 2202. To obtain data for the calibration report 2202, a recorded agent's 127(1-n) interaction with a customer is sent to several evaluators to evaluate the same interaction. Performing calibration can remove subjectivity of the different evaluators. For example, some evaluators may consistently rate agents 127(1-n) more strictly than others, or other evaluators may grade more easily than others, etc. The calibration report 2202 can be calibrated based on a determined baseline average 2204 for the scores. The baseline average 2204 can be entered depending on the calibration report 2202 to be generated, for example, based on averages for past evaluations. The screen 2200 provides that the calibration report 2202 can be obtained from a list 2206, for example by typing a term into a search field 2208 to narrow the options. Once selected, the calibration report 2202 can be generated by clicking on a generate report button 2210.

In addition to generating the calibration report 2202 for checking for statistical measures, e.g., deviation, outliers, average, etc., in some examples the calibration report 2202 can rate certain key performance indicators (KPI) as low because they contradict the business objective. Determined KPIs can also be derived and used for evaluation, e.g., KPIs optimized by the machine learning for this purpose. Evaluees can try to adjust their behavior in order to optimize evaluation score, e.g., by knowing their KPIs and the weight of each KPI. Different evaluator teams can use its own set of KPIs, e.g., selected from a subset from overall pool of KPIs, to check which is better for driving business outcome. The calibration report 2202 can also provide sensitivity analysis, e.g., checking correlation between particular KPI and business outcome. If there is no correlation the KPI can be dropped. Examples of potential bad KPI include short average hold time (AHT)—agents may try to artificially keep calls short, e.g. pick up the call and after few seconds hang up, or wait time—supervisor may implement routing strategy to ignore calls that waited longer than the service level agreement (SLA) and let customers hang up if the hang up does not count as a given KPI. Business conditions and objectives can change, e.g. seasonal, or driven by market or regulations. This can require adjustment of KPIs/weights and evaluations. If a former low weight KPI has now become high value, the calibration report 2202 can re-run previous assessments with new weights in order to find what agents are now the frontrunners. Additionally or alternatively, the calibration report 2202 can provide learning feedback to both evaluators and agents/supervisors.

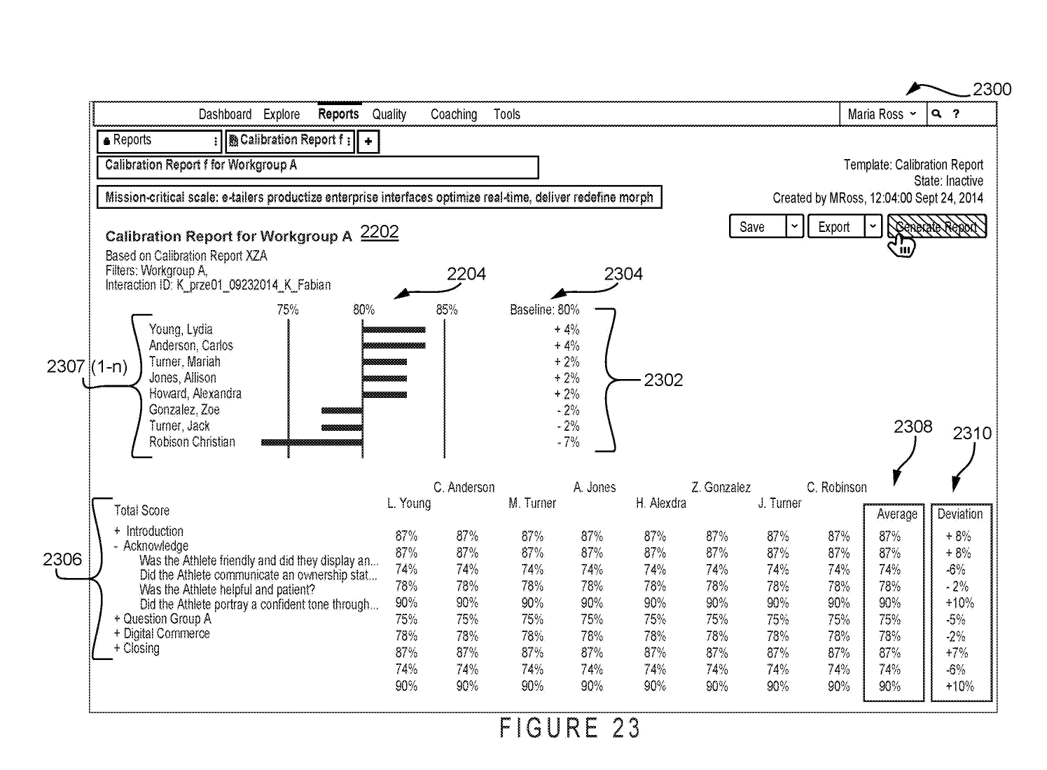

FIG. 23 is a screenshot of an example screen 2300 for a calibration report 2202. The screen 2300 displays variance 2302 for the total scores 2304 per evaluator 2307(1-n), sometimes referred to as an analyst, based on the baseline average 2204. The screen 2300 can also display the scores for the individual questions 2306, e.g., if the correct introduction was provided, questions regarding acknowledgement, specific group questions, digital commerce questions, questions regarding the interaction closing, etc. The screen can display the averages 2308 and deviations 2310 from the baseline 2204, per question. The baseline 2204 can be reevaluated over time, e.g., quarterly. The interaction can also be downgraded for quality issues, e.g., as detected by the analytics server 137. For example, the interaction can be downgraded if the agent was speaking quickly, if the agent was not friendly, etc. The analytics server 137 can perform speech and text analytics to determine the qualities of the interaction.

The calibration report 2202 can be used as a teaching tool for both agents 127(1-n) and evaluators 2307(1-n) for analyzing the interactions. For example, the report can provide example ratings for interactions, e.g., this is an interaction that can be rated a 10, or this interaction is a 5. Additionally, the calibration report 2202 can add contact to the rating. For example, the interaction was a fifth in a series of interactions to solve a customer issue, and in this context the interaction can be rated higher than if the interaction were considered in isolation. The calibration report 2202 can help reduce variance between analysts over time. Additionally or alternatively, a profile can be generated for the analysts to show the evaluators that consistently over/under rate. A normalization factor can be determined for the analysts, e.g., add 1 to Agent A's score and subtract 1 from Agent B's score for the determined analyst based on past experience. Additionally or alternatively, to aid in grading an interaction, the calibration report 2202 can provide typical, calibrated data to be viewed by the evaluator, e.g. if the evaluator rolls over question.

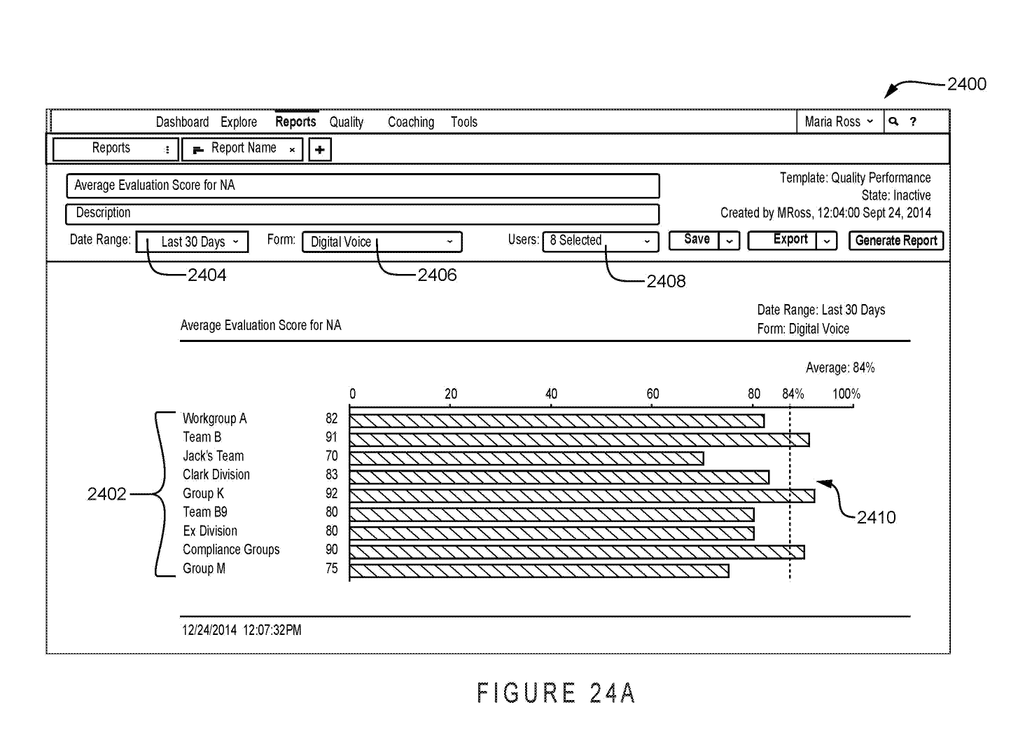

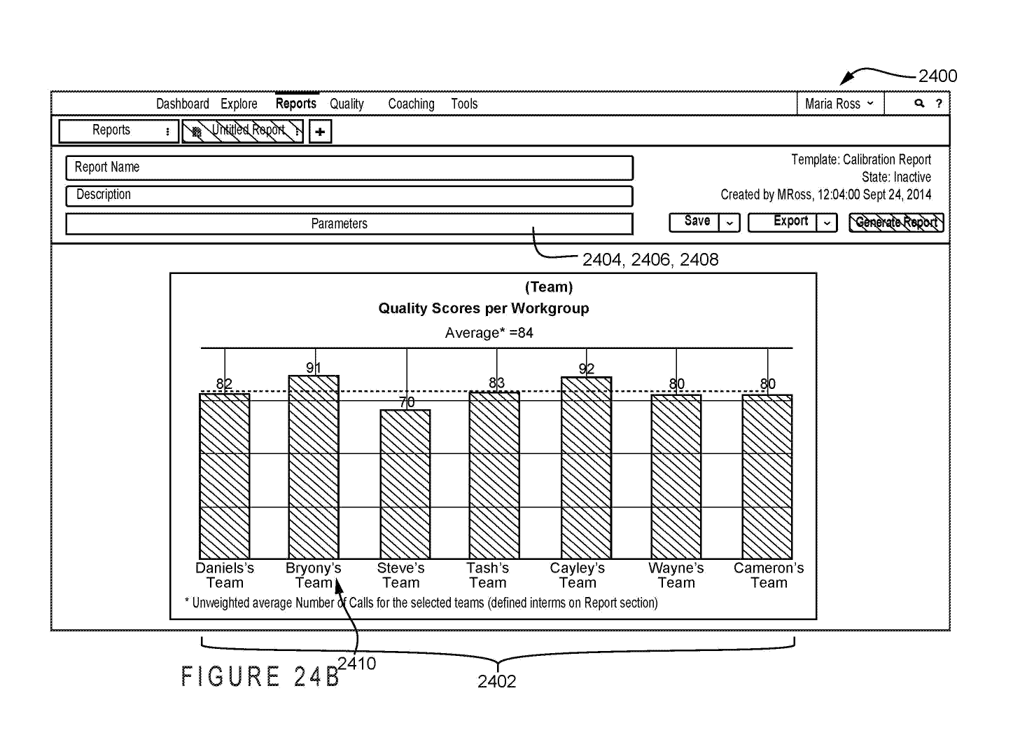

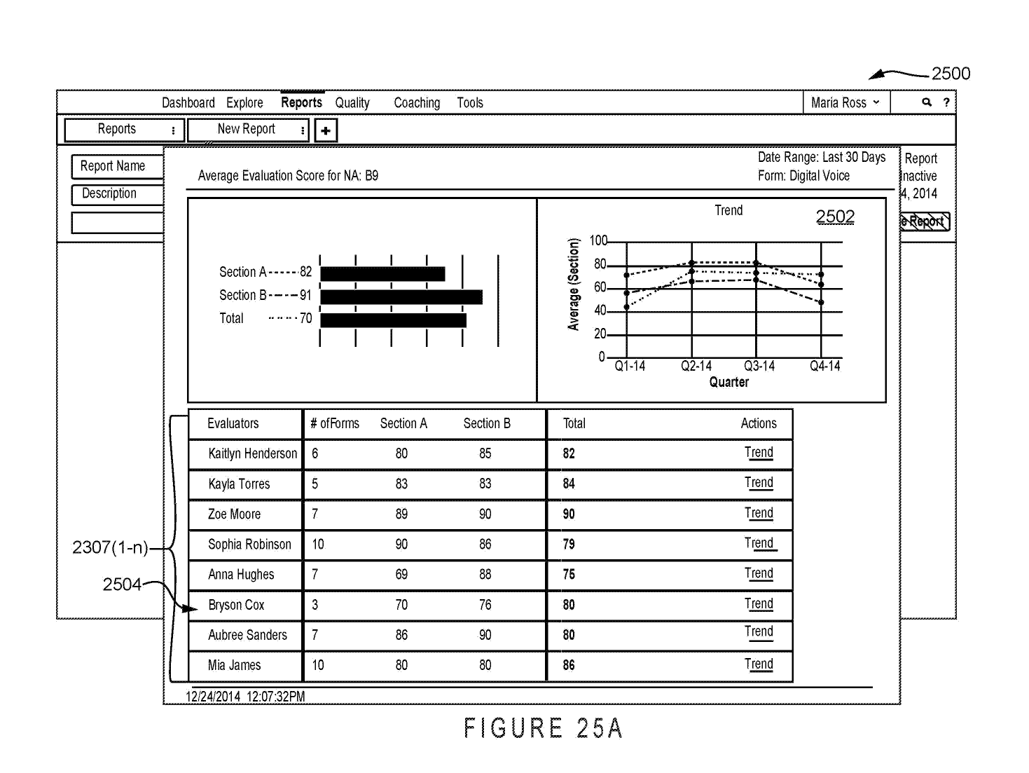

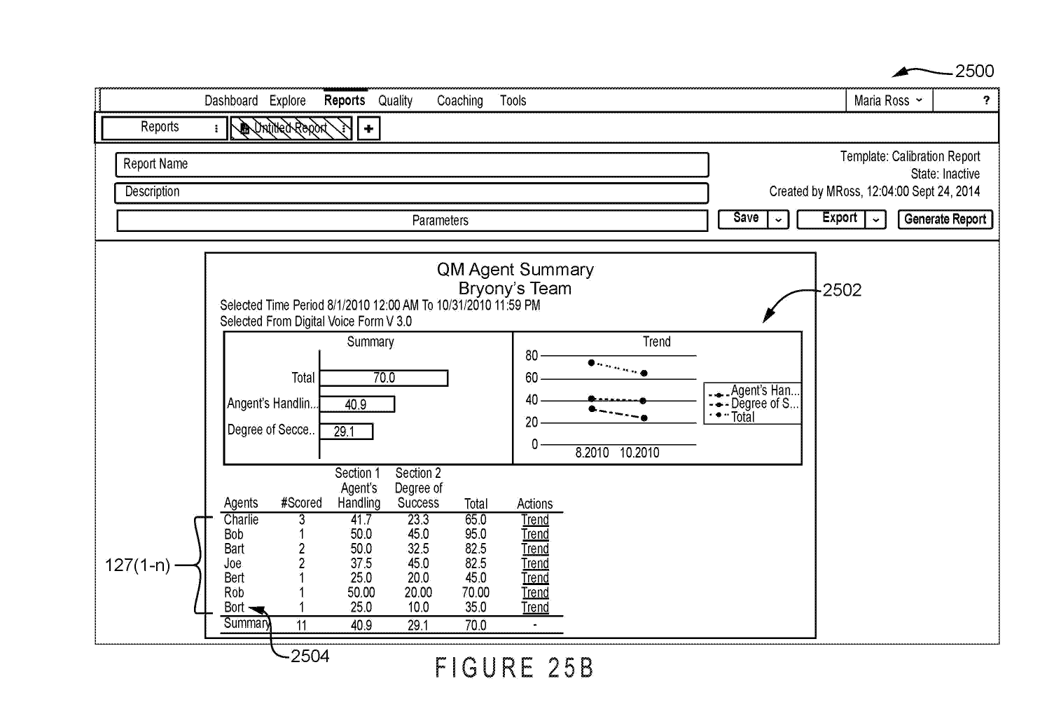

FIGS. 24A and 24B are a screenshots of an example screen 2400 for displaying average evaluations scores by agent team 2402. The screen 2400 can display teams 2402 based on different parameters, e.g., date range 2404, form 2406 and users 2408, including multiple teams, single teams or individuals. The screen 2400 can compare scores for all contact centers within the organization, lines of business within the contact center, teams in the lines of business and agent within the team. The screen 2400 can display the average quality score across all objects being compared, an average score of each object, error bars for outliers, and/or performance relative to benchmarks/expectations. Selecting 2410 a team can provide more detailed information about the team (FIGS. 25A and 25B).

FIGS. 25A and 25B are a screenshots of an example screen 2500 for displaying average evaluation scores for individual teams. The team display 2502 can show a summary of an average quality score of the team and/or a trend of the score of a determined time period. The screen 2500 can also display a list of agents 127(1-n) on the team, a number of evaluations received, an average score, a breakdown of score sections, e.g., from the voice universal playbook form, etc. Clicking trend can display the last evaluations for the agent 127(1-n), what rating each evaluator gave on each questions, and an average score by question/section. The screen 2500 can display the trend information compared to a typical trend learning curve for a given task, e.g., to display whether the agent's trend information fits for the typical learning curve. Decision points along the curve, e.g., determined number of days, can be used to decide whether or not to keep the agent on the given task. Historical trend information can serve as feedback on how suggestions, e.g., ranking, correlate with actual results. This fed back information can lead to adjustment of rankings.

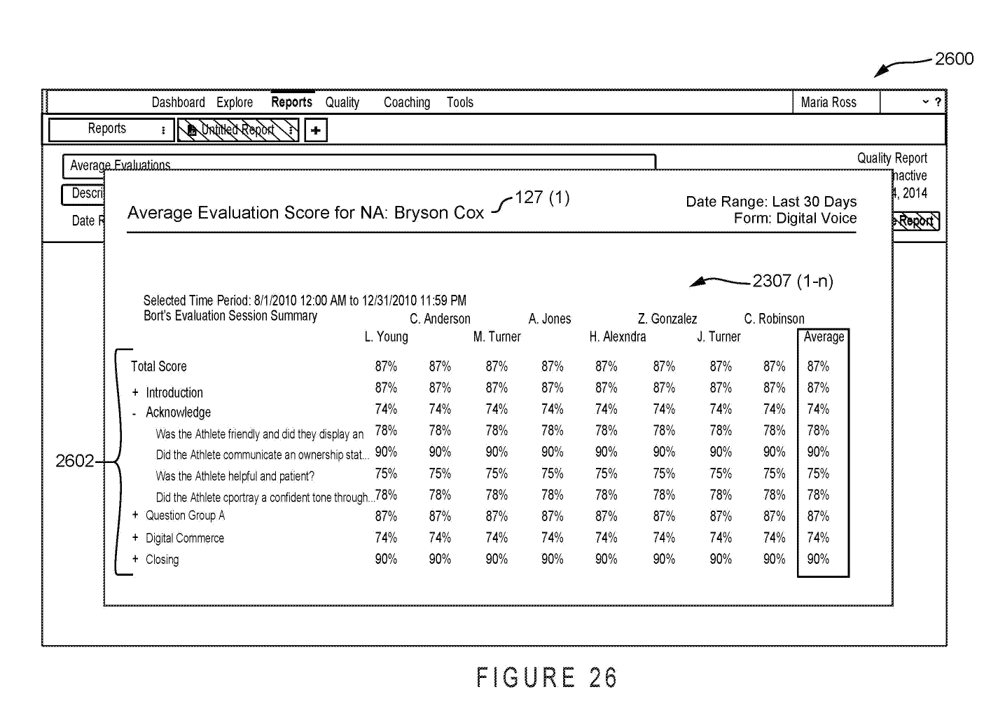

FIG. 26 is a screenshot of an example screen 2600 for displaying average evaluation scores for an individual agent 127(1). The screen 2600 displays each form section and each form question 2602. The form sections can be collapsed to hide the questions and expanded to show the questions. The screen 2600 displays the evaluators 2307(1-n) who evaluated the agent 127(1), what the evaluators scored each question, and the result of each individual evaluation. The display 2600 can also display the agent's 127(1-n) score over all evaluations, sections and questions.

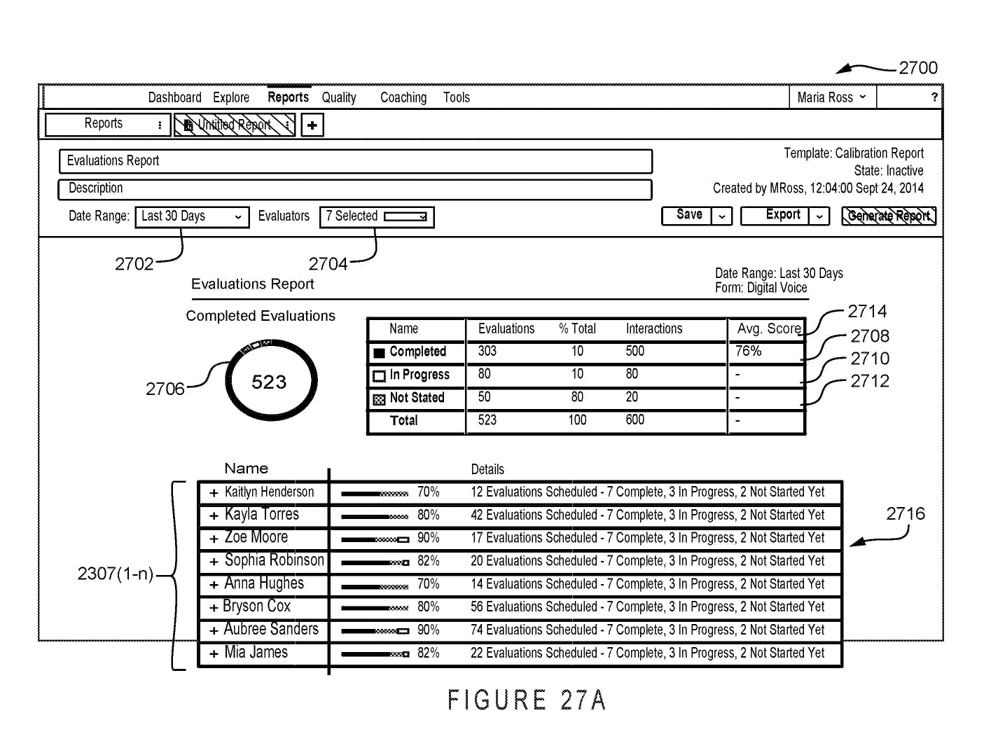

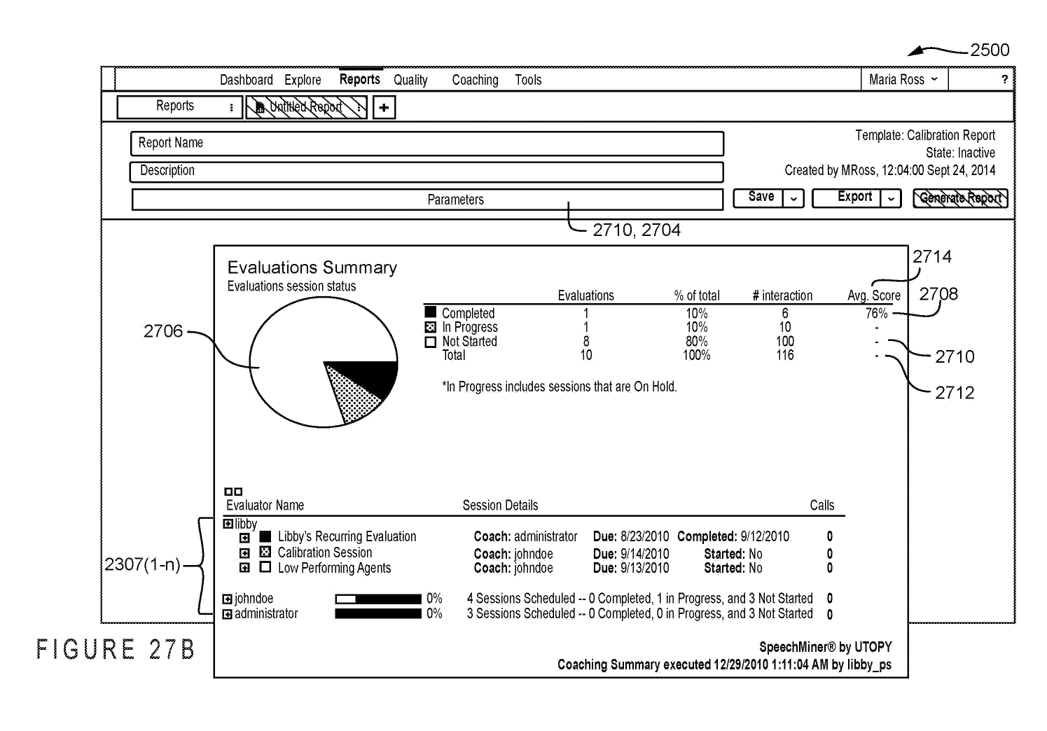

FIGS. 27A and 27B is a screenshot of a screen 2700 of an example screen 2700 for displaying completed evaluation sets to the agents 127(1-n) and/or evaluators 2307(1-n). The screen 2700 can display parameters for selecting an evaluation report, including date range 2702 and evaluations 2704. The screen 2700 displays a number of evaluations 2706, including a number of evaluations completed 2708, a number of evaluations in progress 2710, and a number of evaluations scheduled but not started 2710. The display 2700 shows the average score 2714 for completed evaluations, e.g., over the specified time period. A detailed view can list the questions and answers in the view, how many are scheduled, how many are completed, how many are in progress, and an average score for the evaluations.

The contact center 15 and accompanying systems may be deployed in equipment dedicated to the enterprise or third-party service provider, and/or deployed in a remote computing environment such as, for example, a private or public cloud environment with infrastructure for supporting multiple contact centers for multiple enterprises. The various components of the contact center system may also be distributed across various geographic locations and computing environments and not necessarily contained in a single location, computing environment, or even computing device.

The systems and methods described above may be implemented in many different ways in many different combinations of hardware, software, firmware, or any combination thereof. In one example, the systems and methods can be implemented with a processor and a memory, where the memory stores instructions, which when executed by the processor, causes the processor to perform the systems and methods. The processor may mean any type of circuit such as, but not limited to, a microprocessor, a microcontroller, a graphics processor, a digital signal processor, or another processor. The processor may also be implemented with discrete logic or components, or a combination of other types of analog or digital circuitry, combined on a single integrated circuit or distributed among multiple integrated circuits. All or part of the logic described above may be implemented as instructions for execution by the processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. A product, such as a computer program product, may include a storage medium and computer readable instructions stored on the medium, which when executed in an endpoint, computer system, or other device, cause the device to perform operations according to any of the description above. The memory can be implemented with one or more hard drives, and/or one or more drives that handle removable media, such as diskettes, compact disks (CDs), digital video disks (DVDs), flash memory keys, and other removable media.

The systems and methods can also include a display device, an audio output and a controller, such as a keyboard, mouse, trackball, game controller, microphone, voice-recognition device, or any other device that inputs information. The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. The systems and methods can be implemented over a cloud.

While various embodiments have been described, it can be apparent that many more embodiments and implementations are possible. Accordingly, the embodiments are not to be restricted.

1. A system, comprising:
a contact center to provide an interaction between a customer and agent;
a forms manager of the contact center, the forms manager to generate a question for an evaluation form; and
a workforce management server connected with the forms manager, the workforce management server to schedule a work time for the agent, and the workforce management server to schedule the forms manager to generate the evaluation form when the agent is working.

2. The system of claim 1, where the forms manager generates a calibration report for the evaluation form by sending the evaluation form to a plurality of evaluators for the interaction.

3. The system of claim 2, where the calibration report displays a determined baseline average score for the evaluation form.

4. The system of claim 3, where the calibration report displays a variance from the determined baseline average score for the plurality of evaluators.

5. The system of claim 1, further comprising an analytics server, where the analytics server determines a content of the interaction using analytics; and
the forms manager generates a question for an evaluation form based on the content of the interaction.

6. The system of claim 5, where the analytics comprise at least one of voice analytics, text analytics, chat analytics and web analytics.

7. The system of claim 6, where the analytics server determines a level of background noise during the interaction, and the forms manager generates a question regarding background noise if the analytics server determines that the background noise exceeds a threshold.

8. The system of claim 5, where the analytics server determines that the agent is not a native speaker and the forms manager generates a questions regarding customer comprehension based on the determination.

9. The system of claim 5, where the analytics server determines that an event happens during the interaction that matches a tag, and the forms manager generates a question for the evaluation form based on the determined event.

10. The system of claim 9, where the event comprises the customer cancelling an account.

11. The system of claim 5, where the question comprises a group of questions based on the content of the interaction.

12. The system of claim 5, where the analytics server determines that the customer was upset and the forms manager generates the evaluation form based on the determination that the customer was upset.

13. A method, comprising:
providing, with a processor, an interaction between a customer and an agent;
determining when the agent is working; and
generating an evaluation form for the interaction when the agent is working.

14. The method of claim 13, further comprising generating a calibration report for the evaluation form by sending the evaluation form to a plurality of evaluators for the interaction.

15. The method of claim 13, further comprising analyzing a content of the interaction based on analytics; and
generating a question for an evaluation form based on the content of the interaction.

16. The method of claim 15, further comprising conducting a follow-up call to the customer based on the content of the interaction.

17. The method of claim 13, further comprising determining a level of background noise during the interaction and generating a question for the evaluation form based on the question.

18. A system, comprising:
a contact center to provide an interaction between a customer and agent; and
a forms manager of the contact center, the forms manager to generate a question for an evaluation form, the forms manager to generate a calibration report for the evaluation form by sending the evaluation form to a plurality of evaluators for the interaction.

19. The system of claim 18, where the calibration report displays a determined baseline average score for the evaluation form.

20. The system of claim 19, where the calibration report displays a variance from the determined baseline average score for the plurality of evaluators.
